(19) United States
(12) Patent Application Publication
(10) Pub. No.: US 2019/0113341 A1
(43) Pub. Date: Apr. 18, 2019

(54) Physical Quantity Sensor, Inertial Measurement Device, Vehicle Positioning Device, Portable Electronic Apparatus, Electronic Apparatus, And Vehicle

(71) Applicant: Seiko Epson Corporation, Tokyo (JP)

(72) Inventors: Kazuyuki NAGATA, Minowa (JP); Takayuki KIKUCHI, Chino (JP); Kei KANEMOTO, Fujimi (JP)

(21) Appl. No.: 16/161,480

(22) Filed: Oct. 16, 2018

(30) Foreign Application Priority Data
Oct. 17, 2017 (JP) 2017-201347

(51) Int. Cl. G01C 19/5747; G01C 19/5769; G01C 19/5726; G01C 19/5635

(52) U.S. Cl. CPC G01C 19/5747; G01C 19/5635; G01C 19/5726; G01C 19/5769

(57) ABSTRACT

A physical quantity sensor includes a substrate, a first detection electrode that includes a first electrode finger, a first spring that supports the first detection electrode in a displaceable manner in a first direction with respect to the substrate, a second detection electrode that includes a second electrode finger which is disposed at a distance from the first electrode finger in the first direction, and a second spring that supports the second detection electrode in a displaceable manner in the first direction with respect to the substrate. A spring constant of the first spring in the first direction is equal to a spring constant of the second spring in the first direction.

### CROSS-REFERENCE TO RELATED APPLICATION

This nonprovisional application claims the benefit of Japanese Patent Application No. 2017-201347 filed Oct. 17, 2017, the entire disclosure of which is incorporated herein by reference.

### BACKGROUND

### 1. Technical Field

The present invention relates to a physical quantity sensor, an inertial measurement device, a vehicle positioning device, a portable electronic apparatus, an electronic apparatus, and a vehicle.

### 2. Related Art

In the related art, a configuration described in JP-A-2013-213728 is known as a gyro sensor (angular velocity sensor). The gyro sensor described in JP-A-2013-213728 includes a substrate and an element portion fixed to the substrate. In addition, the element portion includes a frame-shaped vibration portion capable of vibrating in the X-axis direction, a movable drive electrode provided outside the vibration portion, a fixing drive electrode that is fixed to the substrate and vibrates the vibrating portion in the X-axis direction by generating an electrostatic attraction force between the movable drive electrode and the fixing drive electrode, a movable portion that is disposed inside the vibration portion and is displaceable in the Y-axis direction with respect to the vibration portion, a movable detection electrode provided in the movable portion, and a fixing detection electrode that is fixed to the substrate and forms an electrostatic capacitance between the movable detection electrode and the fixing detection electrode. In the gyro sensor, if an angular velocity ωz around the Z axis is applied in a state where the vibrating portion vibrates in the X-axis direction, a displacement portion is displaced in the Y-axis direction by the Coriolis force, and the electrostatic capacitance between the movable detection electrode and the fixing detection electrode is changed. Accordingly, it is possible to detect the angular velocity ωz around the Z axis, based on the change in the electrostatic capacitance.

For example, if an acceleration Ay in the Y-axis direction is applied to the gyro sensor, the movable detection electrode is displaced in the Y-axis direction by the acceleration Ay. Meanwhile, since the fixing detection electrode is fixed to the substrate, the fixing detection electrode is not displaced in the Y-axis direction even if the acceleration Ay is applied. Accordingly, even when the acceleration Ay in the Y-axis direction, which is a physical quantity other than the angular velocity ωz around the Z axis that is a detection target, is applied, the electrostatic capacitance between the movable detection electrode and the fixing detection electrode is changed, and a detection accuracy of the angular velocity ωz around the Z axis that is a detection target is decreased.

### SUMMARY

An advantage of some aspects of the invention is to provide a physical quantity sensor, an inertial measurement device, a vehicle positioning device, a portable electronic apparatus, an electronic apparatus, and a vehicle which can reduce influence on physical quantities other than a physical quantity which is a detection target and can accurately detect the physical quantity which is the detection target.

The invention can be implemented as the following configurations.

A physical quantity sensor according to an aspect of the invention includes a substrate, a first detection electrode that includes a first electrode finger, a first spring that supports the first detection electrode in a displaceable manner in a first direction with respect to the substrate, a second detection electrode that includes a second electrode finger which is disposed at a distance from the first electrode finger in the first direction, and a second spring that supports the second detection electrode in a displaceable manner in the first direction with respect to the substrate. A spring constant of the first spring in the first direction is equal to a spring constant of the second spring in the first direction.

With this configuration, in a case where an acceleration (physical quantity other than a detection target) in a first direction is applied, a first detection electrode and a second detection electrode are displaced in the first direction in the same manner, and thereby, a gap between a first electrode finger and a second electrode finger is not changed substantially. Accordingly, influence on the physical quantity other than the physical quantity which is the detection target is reduced, and a physical quantity sensor capable of accurately detecting the physical quantity which is the detection target is obtained.

In the physical quantity sensor according to the aspect of the invention, it is preferable that the first spring supports the first detection electrode in a displaceable manner in a second direction intersecting the first direction with respect to the substrate, the second spring supports the second detection electrode in a displaceable manner in the second direction with respect to the substrate, and a spring constant of the first spring in the second direction is equal to a spring constant of the second spring in the second direction.

With this configuration, in a case where an acceleration (physical quantity other than a detection target) in a second direction is applied, a first detection electrode and a second detection electrode are displaced in the second direction in the same manner, and thereby, a gap between a first electrode finger and a second electrode finger is not changed substantially. Accordingly, influence on the physical quantity other than the physical quantity which is the detection target is reduced, and a physical quantity sensor capable of accurately detecting the physical quantity which is the detection target is obtained.

In the physical quantity sensor according to the aspect of the invention, it is preferable that the first spring supports the first detection electrode in a displaceable manner in a third direction intersecting each of the first and second directions with respect to the substrate, the second spring supports the second detection electrode in a displaceable manner in the third direction with respect to the substrate, and a spring constant of the first spring in the third direction is equal to a spring constant of the second spring in the third direction.

With this configuration, in a case where an acceleration (physical quantity other than a detection target) in a third direction is applied, a first detection electrode and a second detection electrode are displaced in the third direction in the same manner, and thereby, a gap between a first electrode finger and a second electrode finger is not changed substantially. Accordingly, influence on the physical quantity other than the physical quantity which is the detection target is reduced, and a physical quantity sensor capable of accurately detecting the physical quantity which is the detection target is obtained.

In the physical quantity sensor according to the aspect of the invention, it is preferable that an electrostatic attraction force acts between the first electrode finger and the second electrode finger by applying a potential difference between the first detection electrode and the second detection electrode, and the second electrode finger and the first electrode finger are displaced so as to approach each other by the electrostatic attraction force, and a gap between the first electrode finger and the second electrode finger is reduced more than a gap in a natural state.

With this configuration, it is possible to reduce a gap between a first electrode finger and a second electrode finger compared with a gap in a natural state and to increase detection sensitivity of a physical quantity.

In the physical quantity sensor according to the aspect of the invention, it is preferable that a fixing electrode that is disposed in parallel with the second spring in the first direction is further included, an electrostatic attraction force acts between the second spring and the fixing electrode by applying a potential difference between the second spring and the fixing electrode, and the second detection electrode is displaced in the first direction by the electrostatic attraction force, and a gap between the first electrode finger and the second electrode finger is reduced more than a gap in a natural state.

With this configuration, it is possible to reduce a gap between a first electrode finger and a second electrode finger compared with a gap in a natural state and to increase detection sensitivity of a physical quantity.

In the physical quantity sensor according to the aspect of the invention, it is preferable that a restriction portion that restricts displacement of the second detection electrode in the first direction is further included.

With this configuration, it is possible to suppress excessive displacement of a second detection electrode, for example, it is possible to suppress breakage of a second spring.

In the physical quantity sensor according to the aspect of the invention, it is preferable that as the second spring comes into contact with the restriction portion, the displacement of the second detection electrode in the first direction is restricted.

With this configuration, an excessive displacement of a second detection electrode can be suppressed by using a relatively simple configuration.

In the physical quantity sensor according to the aspect of the invention, it is preferable that a fixing portion that is connected to the second detection electrode via the second spring and is fixed to the substrate is further included, and the fixing portion serves as the restriction portion.

With this configuration, a configuration of a physical quantity sensor is simplified.

A physical quantity sensor according to another aspect of the invention includes a substrate, a first detection electrode that includes a first electrode finger, a first spring that supports the first detection electrode in a displaceable manner in a first direction with respect to the substrate, a second detection electrode that includes a second electrode finger which is disposed at a distance from the first electrode finger in the first direction, and a second spring that supports the second detection electrode in a displaceable manner in the first direction with respect to the substrate. When an acceleration in the first direction is applied, a displacement amount of the first detection electrode in the first direction is equal to a displacement amount of the second detection electrode in the first direction.

With this configuration, in a case where an acceleration (physical quantity other than a detection target) in a first direction is applied, a first detection electrode and a second detection electrode are displaced in the first direction in the same manner, and thereby, a gap between a first electrode finger and a second electrode finger is not changed substantially. Accordingly, influence on the physical quantity other than the physical quantity which is the detection target is reduced, and a physical quantity sensor capable of accurately detecting the physical quantity which is the detection target is obtained.

In the physical quantity sensor according to the aspect of the invention, it is preferable that the first spring supports the first detection electrode in a displaceable manner in a second direction intersecting the first direction with respect to the substrate, the second spring supports the second detection electrode in a displaceable manner in the second direction with respect to the substrate, and when an acceleration in the second direction is applied, a displacement amount of the first detection electrode in the second direction is equal to a displacement amount of the second detection electrode in the second direction.

With this configuration, in a case where an acceleration (physical quantity other than a detection target) in a second direction is applied, a first detection electrode and a second detection electrode are displaced in the second direction in the same manner, and thereby, a gap between a first electrode finger and a second electrode finger is not changed substantially. Accordingly, influence on the physical quantity other than the physical quantity which is the detection target is reduced, and a physical quantity sensor capable of accurately detecting the physical quantity which is the detection target is obtained.

In the physical quantity sensor according to the aspect of the invention, it is preferable that the first spring supports the first detection electrode in a displaceable manner in a third direction intersecting each of the first and second directions with respect to the substrate, the second spring supports the second detection electrode in a displaceable manner in the third direction with respect to the substrate, and when an acceleration in the third direction is applied, a displacement amount of the first detection electrode in the third direction is equal to a displacement amount of the second detection electrode in the third direction.

With this configuration, in a case where an acceleration (physical quantity other than a detection target) in a third direction is applied, a first detection electrode and a second detection electrode are displaced in the third direction in the same manner, and thereby, a gap between a first electrode finger and a second electrode finger is not changed substantially. Accordingly, influence on the physical quantity other than the physical quantity which is the detection target is reduced, and a physical quantity sensor capable of accurately detecting the physical quantity which is the detection target is obtained.

An inertial measurement device according to another aspect of the invention includes the physical quantity sensor according to the aspect of the invention, and a control circuit that controls a drive of the physical quantity sensor.

With this configuration, it is possible to obtain the effects of the physical quantity sensor according to the aspect the invention and to obtain an inertial measurement device with a high reliability.

A vehicle positioning device according to another aspect of the invention includes the inertial measurement device according to the aspect of the invention, a reception unit that receives a satellite signal in which plural pieces of location information are superimposed from a positioning satellite, an acquisition unit that acquires the location information of the reception unit, based on the received satellite signal, a computation unit that computes a posture of a vehicle, based on inertia data that is output from the inertial measurement device, and a calculation unit that calculates a location of the vehicle by correcting the location information, based on the calculated posture.

With this configuration, it is possible to obtain the effects of the inertial measurement device according to the aspect of the invention and to obtain a vehicle positioning device with a high reliability.

A portable electronic apparatus according to another aspect of the invention includes the physical quantity sensor according to the aspect of the invention, a case that stores the physical quantity sensor, a processing unit that is stored in the case and processes output data from the physical quantity sensor, a display unit that is stored in the case, and a light-transmitting cover that covers an opening of the case.

With this configuration, it is possible to obtain the effects of the physical quantity sensor according to the aspect of the invention and to obtain a portable electronic apparatus with a high reliability.

An electronic apparatus according to another aspect of the invention includes the physical quantity sensor according to the aspect of the invention, and a control unit that performs a control based on a detection signal which is output from the physical quantity sensor.

With this configuration, it is possible to obtain the effects of the physical quantity sensor according to the aspect of the invention and to obtain an electronic apparatus with a high reliability.

A vehicle according to another aspect of the invention includes the physical quantity sensor according to the aspect of the invention, and a control unit that performs a control based on a detection signal which is output from the physical quantity sensor.

With this configuration, it is possible to obtain the effects of the physical quantity sensor according to the aspect of the invention and to obtain a vehicle with a high reliability.

### BRIEF DESCRIPTION OF THE DRAWINGS

The invention will be described with reference to the accompanying drawings, wherein like numbers reference like elements.

FIG. 1 is a plan view illustrating a physical quantity sensor according to a first embodiment of the invention.

FIG. 2 is a sectional view taken along line A-A in FIG. 1.

FIG. 3 is a plan view illustrating an element portion included in the physical quantity sensor of FIG. 1.

FIG. 4 is a diagram illustrating voltages applied to the element portion.

FIG. 5 is a schematic diagram illustrating a vibration mode of the element portion.

FIG. 6 is a plan view illustrating a state in which acceleration in the Y-axis direction is applied.

FIG. 7 is a plan view illustrating a state in which acceleration in the X-axis direction is applied.

FIG. 8 is a sectional view illustrating a state in which acceleration in the Z-axis direction is applied.

FIG. 9 is an enlarged plan view illustrating a fixing detection electrode in a displacement state.

FIG. 10 is an enlarged plan view illustrating the fixing detection electrode in a natural state.

FIG. 11 is a plan view illustrating an element portion of a physical quantity sensor according to a second embodiment of the invention.

FIG. 12 is a partially enlarged plan view of the element portion illustrated in FIG. 11.

FIG. 13 is an exploded perspective view of an inertial measurement device according to a third embodiment of the invention.

FIG. 14 is a perspective view of a substrate included in the inertial measurement device illustrated in FIG. 13.

FIG. 15 is a block diagram illustrating an overall system of a vehicle positioning device according to a fourth embodiment of the invention.

FIG. 16 is a view illustrating an operation of the vehicle positioning device illustrated in FIG. 15.

FIG. 17 is a perspective view illustrating an electronic apparatus according to a fifth embodiment of the invention.

FIG. 18 is a perspective view illustrating an electronic apparatus according to a sixth embodiment of the invention.

FIG. 19 is a perspective view illustrating an electronic apparatus according to a seventh embodiment of the invention.

FIG. 20 is a plan view illustrating a portable electronic apparatus according to an eighth embodiment of the invention.

FIG. 21 is a functional block diagram illustrating a schematic configuration of the portable electronic apparatus illustrated in FIG. 20.

FIG. 22 is a perspective view illustrating a vehicle according to a ninth embodiment of the invention.

### DESCRIPTION OF EXEMPLARY EMBODIMENTS

Hereinafter, a physical quantity sensor, an inertial measurement device, a vehicle positioning device, a portable electronic apparatus, an electronic apparatus, and a vehicle according to the invention will be described in detail based on embodiments illustrated in the accompanying drawings.

### First Embodiment

First, a physical quantity sensor according to a first embodiment of the invention will be described.

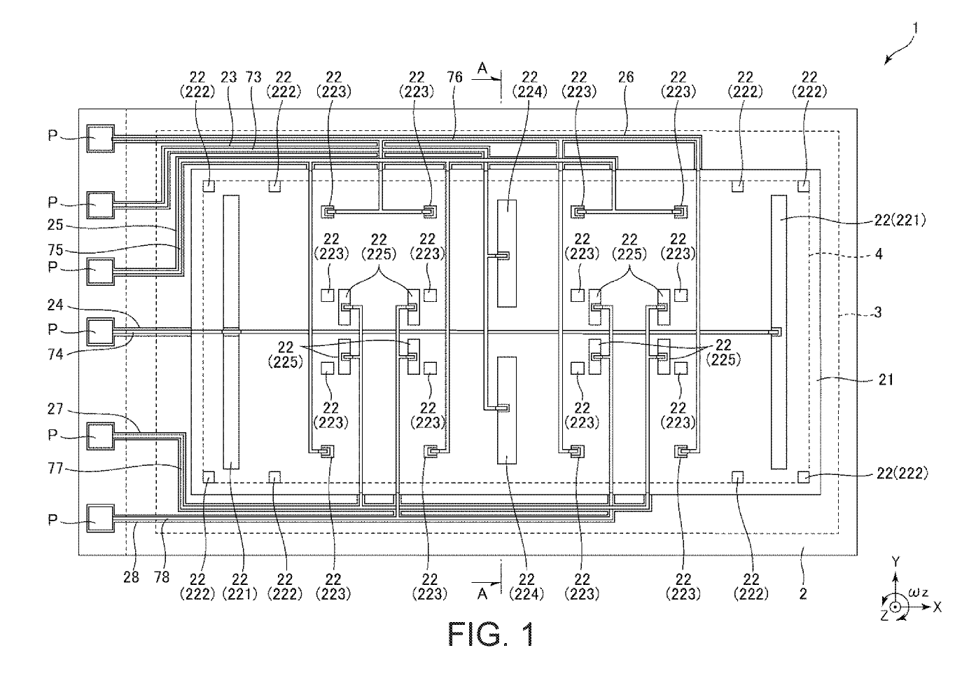

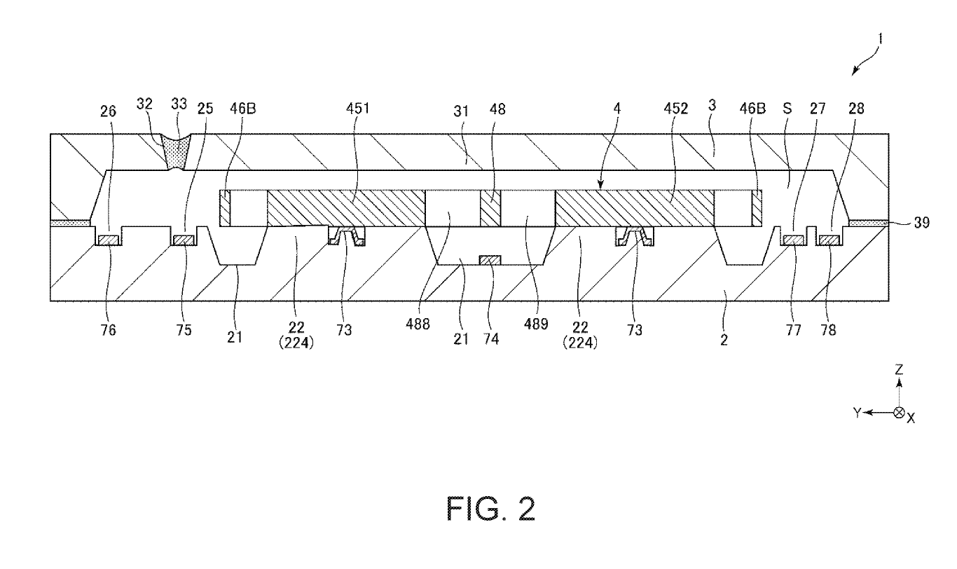

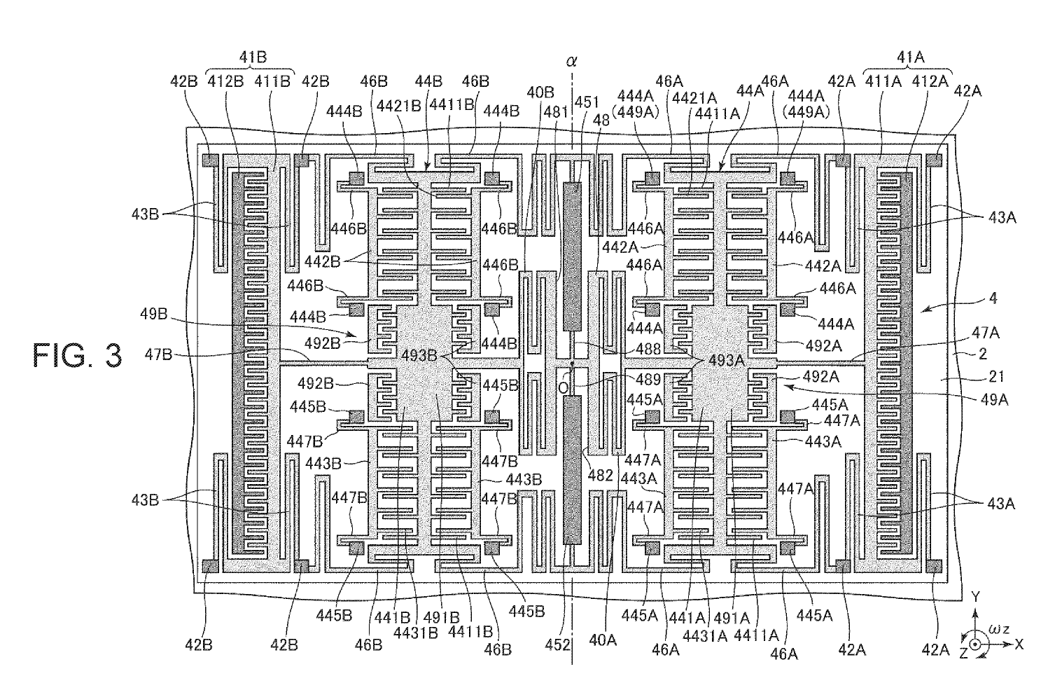

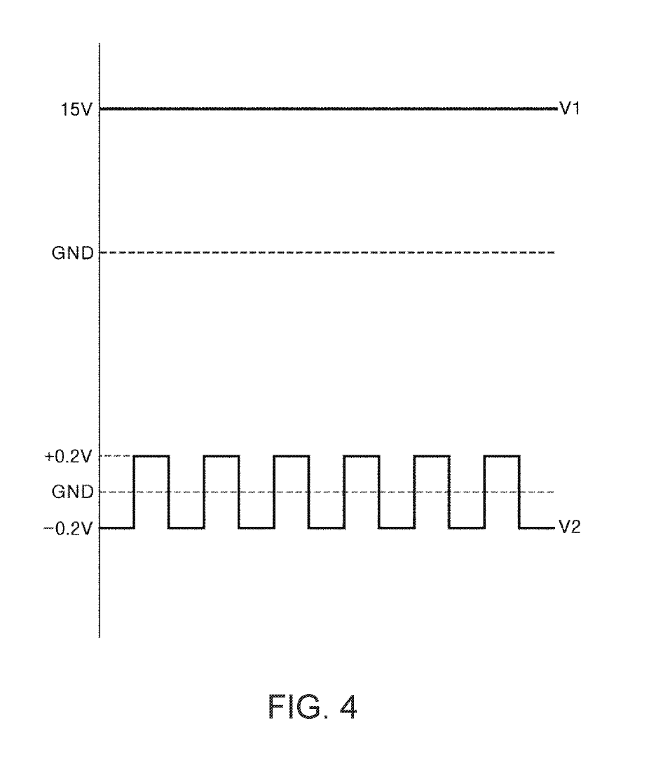

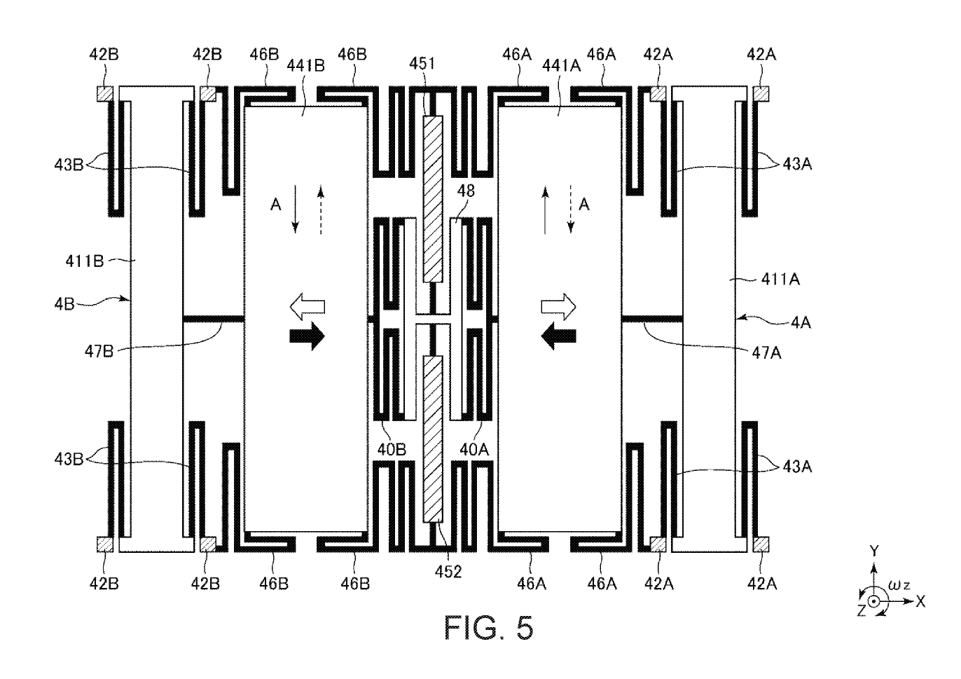

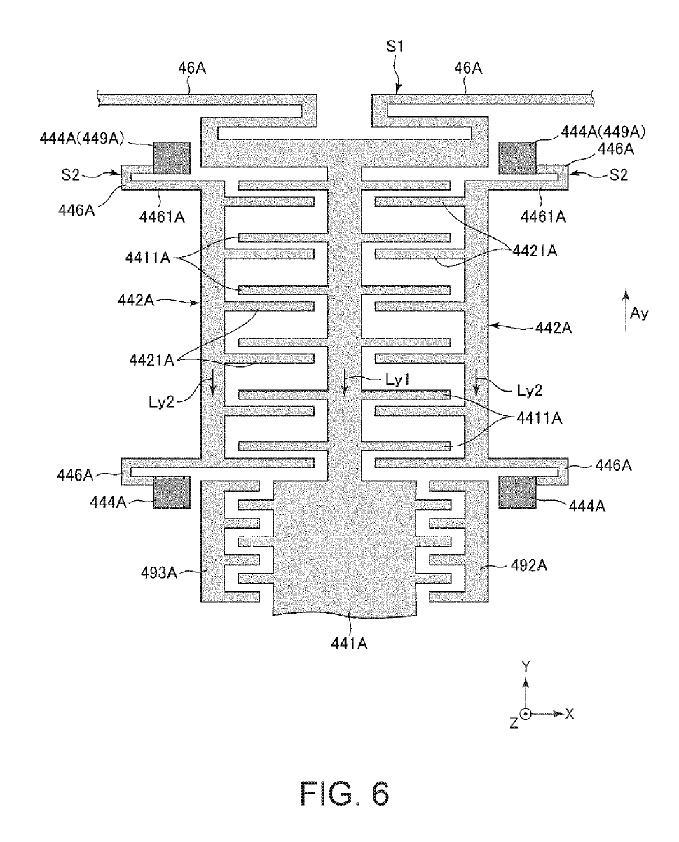

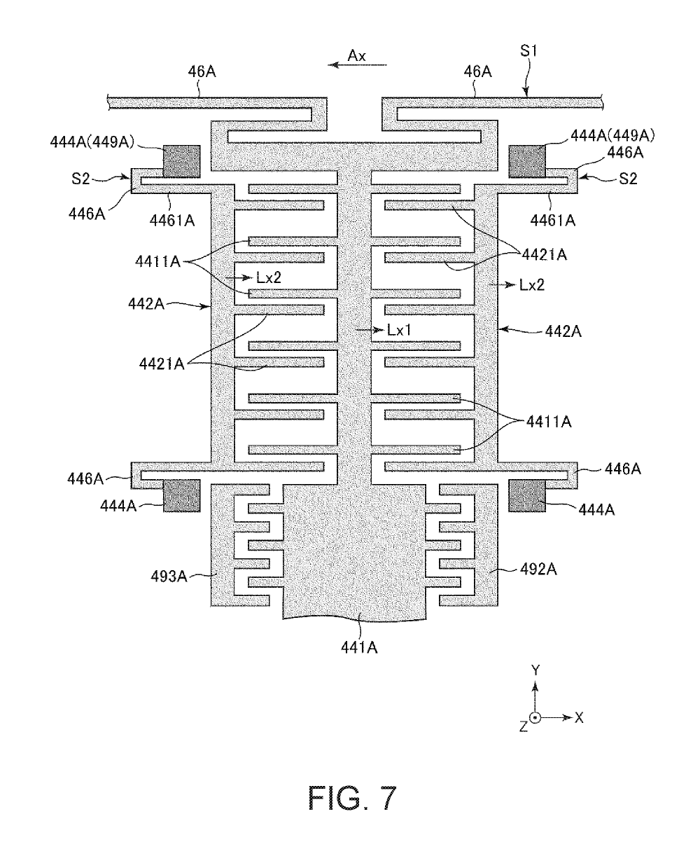

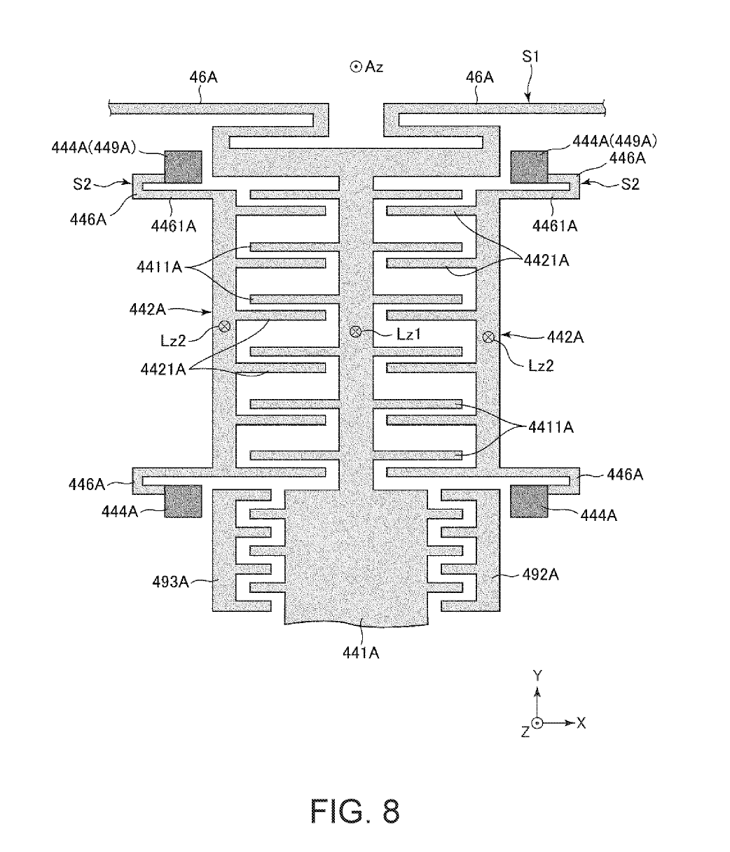

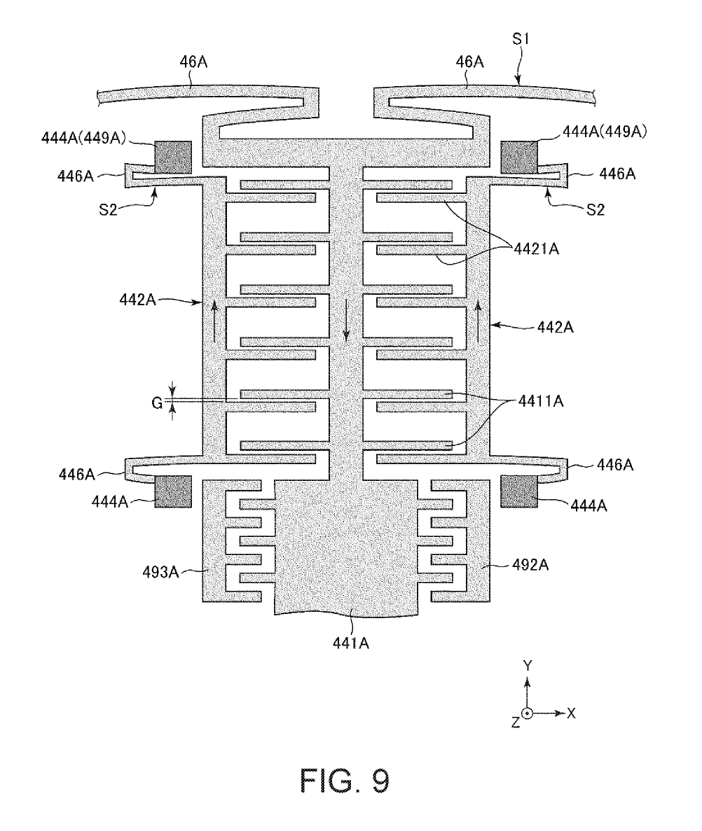

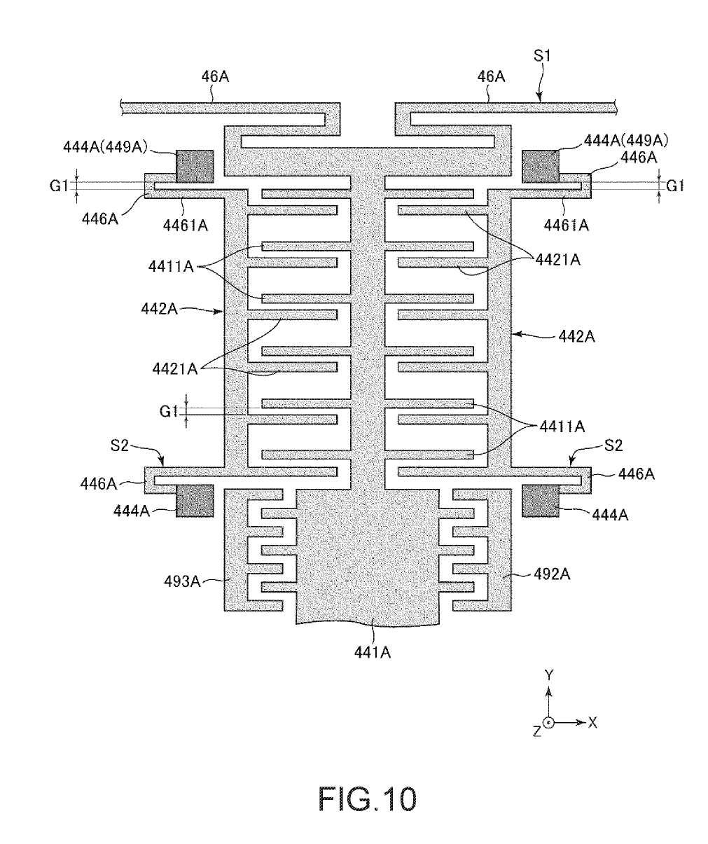

FIG. 1 is a plan view illustrating the physical quantity sensor according to the first embodiment of the invention. FIG. 2 is a sectional view taken along line A-A in FIG. 1. FIG. 3 is a plan view illustrating an element portion included in the physical quantity sensor of FIG. 1. FIG. 4 is a diagram illustrating voltages applied to the element portion. FIG. 5 is a schematic diagram illustrating a vibration mode of the element portion. FIG. 6 is a plan view illustrating a state in which acceleration in the Y-axis direction is applied. FIG. 7 is a plan view illustrating a state in which acceleration in the X-axis direction is applied. FIG. 8 is a sectional view illustrating a state in which acceleration in the Z-axis direction is applied. FIG. 9 is an enlarged plan view illustrating a fixing detection electrode in a displacement state. FIG. 10 is an enlarged plan view illustrating the fixing detection electrode in a natural state.

In each drawing, an X axis, a Y axis, and a Z axis are illustrated as three axes orthogonal to each other. Hereinafter, for the sake of convenient description, a direction parallel to the X axis is referred to as an “X-axis direction”, a direction parallel to the Y axis is referred to as a “Y-axis direction”, and a direction parallel to the Z axis is referred to as a “Z-axis direction”. In addition, a tip side of an arrow of each axis is also referred to as a “plus side”, and an opposite side thereof is also referred to as a “minus side”. In addition, the plus side in the Z-axis direction is also referred to as “upper”, and the minus side in the Z-axis direction is also referred to as “lower”. In the present embodiment, the X axis, the Y axis, and the Z axis are orthogonal to each other, but the axes may not be orthogonal to each other, and may intersect each other.

A physical quantity sensor 1 illustrated in FIG. 1 is an angular velocity sensor capable of detecting an angular velocity ωz around the Z axis. The physical quantity sensor 1 includes a substrate 2, a lid 3, and an element portion 4.

As illustrated in FIG. 1, the substrate 2 has a plate shape of a rectangular plan view shape. In addition, the substrate 2 includes a recessed portion 21 whose upper surface (main surface on the element portion 4 side) is open. The recessed portion 21 is disposed so as to overlap the element portion 4 in a plan view in the Z-axis direction and functions as a relief portion for preventing (suppressing) contact between the element portion 4 and the substrate 2. In addition, the substrate 2 includes a plurality of mounts 22 (221, 222, 223, 224, and 225) projecting from a bottom surface of the recessed portion 21. The element portion 4 is bonded to upper surfaces of the mounts 22. Thereby, the element portion 4 is fixed to the substrate 2 in a state where a contact with the substrate 2 is prevented. In addition, the substrate 2 includes grooves 23, 24, 25, 26, 27, and 28 whose upper surfaces are open.

For example, a glass substrate formed of a glass material (for example, borosilicate glass such as Tempax glass (registered trademark) or Pyrex glass (registered trademark)) containing movable ions (alkali metal ions, hereinafter, Na⁺ is representative) such as sodium ions (Na⁺), and lithium ions (Li⁺) can be used as the substrate 2. Thereby, as will be described below, for example, the substrate 2 and the element portion 4 can be anodically bonded to each other and can be firmly bonded. In addition, since the substrate 2 with light transmittance is obtained, a state of the element portion 4 can be visually recognized from the outside of the physical quantity sensor 1 via the substrate 2. However, a configuration material of the substrate 2 is not limited in particular, and a silicon substrate, a ceramic substrate, or the like may be used therefor.

As illustrated in FIG. 1, wires 73, 74, 75, 76, 77, and 78 are arranged in the grooves 23, 24, 25, 26, 27, and 28, respectively. Each of the wires 73, 74, 75, 76, 77, and 78 is electrically connected to the element portion 4. In addition, one end portion of each of the wires 73, 74, 75, 76, 77, and 78 is exposed to the outside of the lid 3, and functions as an electrode pad P that is electrically connected to an external device.

As illustrated in FIG. 1, the lid 3 has a plate shape of a rectangular plan view shape. In addition, as illustrated in FIG. 2, the lid 3 includes a recessed portion 31 whose lower surface is open. The lid 3 is bonded to an upper surface of the substrate 2 so as to store the element portion 4 in the recessed portion 31. A storage space S for storing the element portion 4 therein is formed by the lid 3 and the substrate 2.

In addition, as illustrated in FIG. 2, the lid 3 includes a communication hole 32 that communicates between the inside and the outside of the storage space S. Accordingly, it is possible to replace the storage space S with a desirable atmosphere via the communication hole 32. In addition, a sealing member 33 is disposed in the communication hole 32, and the communication hole 32 is airtightly sealed by the sealing member 33. It is preferable that the storage space S is in a reduced pressure state, particularly in a vacuum state. Thereby, viscous resistance is reduced, and the element portion 4 can vibrate efficiently.

For example, a silicon substrate can be used as the lid 3. However, the lid 3 is not limited in particular, and for example, a glass substrate or a ceramic substrate may be used therefor. In addition, a method of bonding the substrate 2 and the lid 3 is not limited in particular and may be appropriately selected from among materials of the substrate 2 and the lid 3. For example, anodic bonding, activation bonding for bonding together bonding surfaces activated by plasma irradiation, bonding made with a bonding material such as a glass frit, diffusion bonding for bonding metal films formed on an upper surface of the substrate 2 and a lower surface of the lid 3, and the like are used as the bonding method. In the present embodiment, the substrate 2 and the lid 3 are bonded together via a glass frit 39 (low melting point glass).

The element portion 4 is disposed in the storage space S and is bonded to the upper surfaces of the mounts 22. The element portion 4 can be formed by patterning a conductive silicon substrate doped with impurities such as phosphorus (P), boron (B) or the like by using a dry etching method (silicon deep etching: Bosch method). Hereinafter, the element portion 4 will be described in detail. Hereinafter, a straight line intersecting the center O of the element portion 4 and extending in the Y-axis direction in a plan view in the Z-axis direction is also referred to as a “virtual straight line α.

As illustrated in FIG. 3, a shape of the element portion 4 is symmetrical with respect to the virtual straight line α. In addition, the element portion 4 includes drive portions 41A and 41B disposed on both sides of the virtual straight line α. The drive portion 41A includes a movable drive electrode 411A including a plurality of electrode fingers arranged in a comb shape, and a fixing drive electrode 412A which includes a plurality of electrode fingers arranged in a comb shape and is disposed to be in mesh with the electrode fingers of the movable drive electrode 411A. In the same manner, the drive portion 41B includes a movable drive electrode 411B including a plurality of electrode fingers arranged in a comb shape, and a fixing drive electrode 412B which includes a plurality of electrode fingers arranged in a comb shape and is disposed to be in mesh with the electrode fingers of the movable drive electrode 411B.

In addition, the fixing drive electrode 412A is located on the outside (side farther from the virtual straight line α) more than the movable drive electrode 411A, and the fixing drive electrode 412B is located on the outside (side farther from the virtual straight line α) more than the movable drive electrode 411B. In addition, the fixing drive electrodes 412A and 412B are bonded to an upper surface of the mount 221 and fixed to the substrate 2, respectively. Each of the movable drive electrodes 411A and 411B is electrically connected to the wire 73, and each of the fixing drive electrodes 412A and 412B is electrically connected to the wire 74.

In addition, the element portion 4 includes four fixing portions 42A arranged around the drive portion 41A and four fixing portions 42B arranged around the drive portion 41B. Each of the fixing portions 42A and 42B is bonded to the upper surface of the mount 222 and is fixed to the substrate 2.

The element portion 4 includes four drive springs 43A connecting the respective fixing portions 42A to the movable drive electrode 411A, and four drive springs 43B connecting the respective fixing portions 42B to the movable drive electrode 411B. Each of the drive springs 43A is elastically deformed in the X-axis direction, and thereby, displacement of the movable drive electrode 411A in the X-axis direction is allowed, and each of the drive spring 43B is elastically deformed in the X-axis direction, and thereby, displacement of the movable drive electrode 411B in the X-axis direction is allowed.

In order to vibrate the movable drive electrodes 411A and 411B in the X-axis direction, for example, a voltage V1 illustrated in FIG. 4 is applied to the movable drive electrodes 411A and 411B via the wire 73 and a voltage V2 illustrated in FIG. 4 is applied to the fixing drive electrodes 412A and 412B via the wire 74. The voltage V1 is a constant voltage of approximately 15 V which is larger than a GND reference (for example, a potential of approximately 0.9 V), and the voltage V2 is a rectangular wave formed above and below the GND reference.

Thereby, electrostatic attraction forces are generated between the movable drive electrode 411A and the fixing drive electrode 412A and between the movable drive electrode 411B and the fixing drive electrode 412B, the movable drive electrode 411A vibrates in the X-axis direction while elastically deforming the drive spring 43A, and the movable drive electrode 411B vibrates in the X-axis direction while elastically deforming the drive spring 43B. As described above, the drive portions 41A and 41B are disposed symmetrically with respect to the virtual straight line α, and the movable drive electrodes 411A and 411B vibrate in opposite phases in the X-axis direction so as to repeat approaching and separating from each other. Accordingly, the vibrations of the movable drive electrodes 411A and 411B are canceled, and vibration leakage to the substrate 2 can be reduced. Hereinafter, this vibration mode is also referred to as a “drive vibration mode”.

As long as the drive vibration mode can be excited, the voltages V1 and V2 are not limited in particular. In addition, in the physical quantity sensor 1 according to the present embodiment, an electrostatic drive method is used in which the drive vibration mode is excited by the electrostatic attraction force, but the exciting method is not limited in particular, and, for example, a piezoelectric drive method, an electromagnetic drive method using a Lorentz force of a magnetic field, or the like can also be applied.

In addition, the element portion 4 includes detection portions 44A and 44B disposed between the drive portions 41A and 41B. The detection portion 44A includes a movable detection electrode 441A including a plurality of electrode fingers 4411A arranged in a comb shape, and fixing detection electrodes 442A and 443A which include a plurality of electrode fingers 4421A and 4431A arranged in a comb shape and disposed to be in mesh with the electrode fingers 4411A of the movable detection electrode 441A. The fixing detection electrodes 442A and 443A are disposed side by side in the Y-axis direction, the fixing detection electrode 442A is located on the plus side in the Y-axis direction with respect to the center of the movable detection electrode 441A, and the fixing detection electrode 443A is located on the minus side in the Y-axis direction. In addition, the fixing detection electrodes 442A and 443A are disposed in a pair so as to interpose the movable detection electrode 441A from both sides in the X-axis direction. In addition, the electrode fingers 4421A are located on the minus side in the Y-axis direction with respect to the facing electrode fingers 4411A, and the electrode fingers 4431A are located on the plus side in the Y-axis direction with respect to the facing electrode fingers 4411A.

Likewise, the detection portion 44B includes a movable detection electrode 441B including a plurality of electrode fingers 4411B arranged in a comb shape, and fixing detection electrodes 442B and 443B which include a plurality of electrode fingers 4421B and 4431B arranged in a comb shape and are disposed so as to be in mesh with the electrode fingers 4411B of the movable detection electrode 441B. The fixing detection electrodes 442B and 443B are disposed side by side in the Y-axis direction, the fixing detection electrode 442B is located on the plus side in the Y-axis direction with respect to the center of the movable detection electrode 441B, and the fixing detection electrode 443B is located on the minus side in the Y-axis direction. In addition, the fixing detection electrodes 442B and 443B are disposed in a pair so as to interpose the movable detection electrodes 441B from both sides in the X-axis direction. In addition, the electrode fingers 4421B are located on the minus side in the Y-axis direction with respect to the facing electrode fingers 4411B, and the electrode fingers 4431B are located on the plus side in the Y-axis direction with respect to the facing electrode fingers 4411B.

Here, the “movable” of the movable detection electrodes 441A and 441B indicates vibration in a drive vibration mode or a detection vibration mode, and the “fixing” of the fixing detection electrodes 442A, 443A, 442B, and 443B indicates that there is no substantial vibration in the drive vibration mode or the detection vibration mode, as will be described below.

The movable detection electrodes 441A and 441B are electrically connected to the wire 73, the fixing detection electrodes 442A and 443B are electrically connected to the wire 75, and the fixing detection electrodes 443A and 442B are electrically connected to the wire 76. In addition, each of the wires 75 and 76 is connected to a QV amplifier (charge voltage conversion circuit). When the physical quantity sensor 1 is driven, an electrostatic capacitance Ca is formed between the movable detection electrode 441A and the fixing detection electrode 442A and between the movable detection electrode 441B and the fixing detection electrode 443B, and an electrostatic capacitance Cb is formed between the movable detection electrode 441A and the fixing detection electrode 443A and between the movable detection electrode 441B and the fixing detection electrode 442B.

In addition, the element portion 4 includes two fixing portions 451 and 452 disposed between the detection portions 44A and 44B. Each of the fixing portions 451 and 452 is bonded to an upper surface of the mount 224 and is fixed to the substrate 2. The fixing portions 451 and 452 are aligned in the Y-axis direction and are spaced apart from each other. In the present embodiment, the movable drive electrodes 411A and 411B and the movable detection electrodes 441A and 441B are electrically connected to the wire 73 via the fixing portions 451 and 452.

In addition, the element portion 4 includes four detection springs 46A that connect the movable detection electrode 441A to the fixing portions 42A, 451, and 452, and four detection springs 46B that connect the movable detection electrode 441B to the fixing portions 42B, 451, and 452. Each of the detection springs 46A is elastically deformed in the X-axis direction to allow displacement of the movable detection electrode 441A in the X-axis direction and is elastically deformed in the Y-axis direction to allow displacement of the movable detection electrode 441A in the Y-axis direction. Likewise, each of the detection springs 46B is elastically deformed in the X-axis direction to allow displacement of the movable detection electrode 441B in the X-axis direction and is elastically deformed in the Y-axis direction to allow displacement of the movable detection electrode 441B in the Y-axis direction.

In addition, the element portion 4 includes two fixing portions 444A disposed near each of the fixing detection electrodes 442A, two fixing portions 445A disposed near each of the fixing detection electrodes 443A, two fixing portions 444B disposed near each of the fixing detection electrodes 442B, and two fixing portions 445B disposed near each of the fixing detection electrodes 443B. Each of the fixing portions 444A, 445A, 444B, and 445B is bonded to an upper surface of the mount 223 and is fixed to the substrate 2.

In addition, the element portion 4 includes two springs 446A connecting the fixing detection electrode 442A to each of the fixing portions 444A, two springs 447A connecting the fixing detection electrode 443A to the two fixing portions 445A, two springs 446B connecting the fixing detection electrode 442B to each of the two fixing portions 444B, and two springs 447B connecting the fixing detection electrode 443B to the two fixing portions 445B. Each spring 446A is elastically deformed in the Y-axis direction to allow displacement of the fixing detection electrode 442A in the Y-axis direction, and each spring 447A is elastically deformed in the Y-axis direction to allow displacement of the fixing detection electrode 443A in the Y-axis direction, each spring 446B is elastically deformed in the Y-axis direction to allow displacement of the fixing detection electrode 442B in the Y-axis direction, and each spring 447B is elastically deformed in the Y-axis direction to allow displacement of the fixing detection electrode 443B in the Y-axis direction.

In addition, the element portion 4 includes a beam 47A which is located between the movable drive electrode 411A and the movable detection electrode 441A and connects the movable drive electrode 411A to the movable detection electrode 441A, and a beam 47B which is located between the movable drive electrode 411B and the movable detection electrode 441B and connects the movable drive electrode 411B to the movable detection electrode 441B. Accordingly, as illustrated in FIG. 5, in the drive vibration mode, a movable body 4A which is an assembly of the movable drive electrode 411A, the movable detection electrode 441A, and the beam 47A, and a movable body 4B which is an assembly of the movable drive electrode 411B, the movable detection electrode 441B, and the beam 47B vibrate in opposite phases in the X-axis direction. The beams 47A and 47B function as beams by being stretched in the X-axis direction and do not hinder the excitation of the detection vibration mode which will be described below by being elastically deformed in the Y-axis direction.

If the angular velocity ωz is applied to the physical quantity sensor 1 during driving in the drive vibration mode, the movable detection electrodes 441A and 441B vibrate in opposite phases in the Y-axis direction (this vibration is also referred to as the “detection vibration mode”) while elastically deforming the detection springs 46A and 46B in the Y-axis direction by using the Coriolis force as indicated by an arrow A illustrated in FIG. 5. In the detection vibration mode, the movable detection electrodes 441A and 441B vibrate in the Y-axis direction, and thereby, a gap between the movable detection electrode 441A and the fixing detection electrodes 442A and 443A and a gap between the movable detection electrode 441B and the fixing detection electrodes 442B and 443B are changed, and accordingly, the electrostatic capacitances Ca and Cb change. Accordingly, the angular velocity ωz can be obtained based on the changes in the electrostatic capacitances Ca and Cb.

In the detection vibration mode, if the electrostatic capacitance Ca increases, the electrostatic capacitance Cb decreases, and in contrast to this, if the electrostatic capacitance Ca decreases, the electrostatic capacitance Cb increases. Accordingly, a differential computation (subtraction processing: Ca−Cb) between a detection signal (signal corresponding to a magnitude of the electrostatic capacitance Ca) output from the QV amplifier connected to the wire 75 and a detection signal (signal corresponding to a magnitude of the electrostatic capacitance Cb) output from the QV amplifier connected to the wire 76 is performed, and thereby, noise can be canceled and the angular velocity ωz can be detected more accurately.

In addition, as illustrated in FIG. 3, the element portion 4 includes a frame 48 located at the central portion (between the detection portions 44A and 44B). The frame 48 has an “H” shape and includes a defect portion 481 (recessed portion) located on the plus side in the Y-axis direction and a defect portion 482 (recessed portion) located on the minus side in the Y-axis direction. A fixing portion 451 is disposed across the inside and outside of the defect portion 481, and a fixing portion 452 is disposed across the inside and outside of the defect portion 482. Thereby, the fixing portions 451 and 452 can be formed long in the Y-axis direction, a bonding area with the substrate 2 increases correspondingly, and a bonding strength between the substrate 2 and the element portion 4 increases.

In addition, the element portion 4 includes a frame spring 488 which is located between the fixing portion 451 and the frame 48 and connects the fixing portion 451 to the frame 48, and a frame spring 489 which is located between the fixing portion 452 and the frame 48 and connects the fixing portion 452 to the frame 48.

In addition, the element portion 4 includes a connection spring 40A which is located between the frame 48 and the movable detection electrode 441A and connects the frame 48 to the movable detection electrode 441A, and a connection spring 40B which is located between the frame 48 and the movable detection electrode 441B and connects the frame 48 to the movable detection electrode 441B. The connection spring 40A supports the movable detection electrode 441A together with the detection spring 46A, and the connection spring 40B supports the movable detection electrode 441B together with the detection spring 46B. Accordingly, the movable detection electrodes 441A and 441B can be supported in a stable posture, and unnecessary vibration (spurious) of the movable detection electrodes 441A and 441B can be reduced.

In the drive vibration mode, the connection springs 40A and 40B are elastically deformed, and thereby, vibration of the movable bodies 4A and 4B is allowed, and in the detection vibration mode, the connection springs 40A and 40B and the frame springs 488 and 489 are elastically deformed and the frame 48 rotates (inclines) around the center O, and thereby, vibration of the movable detection electrodes 441A and 441B in the Y-axis direction is allowed.

In addition, the element portion 4 includes monitor portions 49A and 49B for detecting a vibration state of the movable bodies 4A and 4B in the drive vibration mode. The monitor portion 49A includes a movable monitor electrode 491A which is disposed in the movable detection electrode 441A and includes a plurality of electrode fingers arranged in a comb shape, and fixing monitor electrodes 492A and 493A which include a plurality of electrode fingers arranged in a comb shape and disposed to be in mesh with the electrode fingers of the movable monitor electrodes 491A. The fixing monitor electrode 492A is located on the plus side in the X-axis direction with respect to the movable monitor electrode 491A, and the fixing monitor electrode 493A is located on the minus side in the X-axis direction with respect to the movable monitor electrode 491A.

Likewise, the monitor portion 49B includes a movable monitor electrode 491B which is disposed in the movable detection electrode 441B and includes a plurality of electrode fingers arranged in a comb shape, and fixing monitor electrodes 492B and 493B which include a plurality of electrode fingers arranged in a comb shape and disposed to be in mesh with the electrode fingers of the movable monitor electrodes 491B. The fixing monitor electrode 492B is located on the minus side in the X-axis direction with respect to the movable monitor electrode 491B, and the fixing monitor electrode 493B is located on the plus side in the X-axis direction with respect to the movable monitor electrode 491B.

These fixing monitor electrodes 492A, 493A, 492B, and 493B are respectively bonded to an upper surface of the mount 225 and are fixed to the substrate 2. In addition, the movable monitor electrodes 491A and 491B are electrically connected to the wire 73, the fixing monitor electrodes 492A and 492B are electrically connected to the wire 77, and the fixing monitor electrodes 493A and 493B are electrically connected to the wire 78. In addition, the wires 77 and 78 are connected to the QV amplifier (charge voltage conversion circuit). When the physical quantity sensor 1 is driven, an electrostatic capacitance Cc is formed between the movable monitor electrode 491A and the fixing monitor electrode 492A and between the movable monitor electrode 491B and the fixing monitor electrode 492B, and an electrostatic capacitance Cd is formed between the movable monitor electrode 491A and the fixing monitor electrode 493A and between the movable monitor electrode 491B and the fixing monitor electrode 493B.

As described above, in the drive vibration mode, the movable detection electrodes 441A and 441B vibrate in the X-axis direction, and thereby, a gap between the movable monitor electrode 491A and the fixing monitor electrodes 492A and 493A, a gap between the movable monitor electrode 491B and the fixing monitor electrode 492B and 493B are changed, and accordingly, the electrostatic capacitances Cc and Cd are changed. Accordingly, it is possible to detect a vibration state (particularly, an amplitude in the X-axis direction) of the movable bodies 4A and 4B, based on the changes in the electrostatic capacitances Cc and Cd.

In the drive vibration mode, if the electrostatic capacitance Cc increases, the electrostatic capacitance Cd decreases, and in contrast to this, if the electrostatic capacitance Cc decreases, the electrostatic capacitance Cd increases. Accordingly, a differential computation (subtraction processing: Cc−Cd) between a detection signal (signal corresponding to a magnitude of the electrostatic capacitance Cc) obtained from the QV amplifier connected to the wire 77 and a detection signal (signal corresponding to a magnitude of the electrostatic capacitance Cd) obtained from the QV amplifier connected to the wire 78 is performed, and thereby, noise can be canceled and the variation state of the movable bodies 4A and 4B can be detected more accurately.

The vibration state (amplitude) of the movable bodies 4A and 4B detected by the outputs from the monitor portions 49A and 49B is fed back to a drive circuit that applies the voltage V2 to the movable bodies 4A and 4B. The drive circuit changes a frequency and a duty of the voltage V2 such that amplitudes of the movable bodies 4A and 4B become a target value. Thereby, the movable bodies 4A and 4B can vibrate more reliably with a predetermined amplitude, and a detection accuracy of the angular velocity ωz is increased.

The configuration of the element portion 4 is briefly described above. Next, the fixing detection electrodes 442A, 443A, 442B, and 443B which are one of characteristics of the physical quantity sensor 1 will be described in more detail. However, since the fixing detection electrodes 442A, 443A, 442B, and 443B have the same configuration, the fixing detection electrode 442A will be hereinafter described as a representative for the sake of convenient description, and description on the other fixing detection electrodes 443A, 442B, and 443B will be omitted.

In the physical quantity sensor 1, as illustrated in FIG. 6, when an acceleration Ay in the Y-axis direction is applied, a displacement amount Ly2 of the fixing detection electrode 442A in the Y-axis direction caused by the acceleration Ay is equal to a displacement amount Ly1 of the movable detection electrode 441A in the Y-axis direction caused by the acceleration Ay. As such, by making the displacement amounts Ly1 and Ly2 equal to each other, even if the acceleration Ay is applied, a gap G between the electrode fingers 4411A and 4421A does not substantially change (the gap G is kept constant). Thus, according to the physical quantity sensor 1, it is possible to reduce influence on the physical quantity (acceleration Ay) other than the angular velocity ωz which is a detection target, and to detect more accurately the angular velocity ωz. The fact that the displacement amounts Ly1 and Ly2 are equal to each other means not only a case where the displacement amounts Ly1 and Ly2 coincide with each other (Ly1=Ly2) but also a case where displacement amounts Ly1 and Ly2 are somewhat different, for example, there is a technically unavoidable error and a range of 0.9≤Ly1/Ly2≤1.1 is included.

In the physical quantity sensor 1, a spring constant ky2 of a second spring S2 in the Y-axis direction which supports the fixing detection electrode 442A is set to be equal to a spring constant ky1 of a first spring S1 in the Y-axis direction which supports the movable detection electrode 441A. Thereby, the displacement amounts Ly1 and Ly 2 can be equalized to each other easily and reliably. Here, the first spring S1 is configured with all springs that support the movable detection electrode 441A in a displaceable manner, specifically, each detection spring 446A, the drive spring 43A, the connection spring 40A, and the frame springs 488 and 489, and the beam 47A. Meanwhile, the second spring S2 is configured with all springs that support the fixing detection electrode 442A in a displaceable manner, specifically, two springs 446A. The fact that the spring constants ky1 and ky2 are equal to each other means not only a case where the spring constants ky1 and ky2 coincide with each other (ky1=ky2) but also a case where ky1 and ky2 are somewhat different from each other, for example, there is a technically unavoidable error and a range of 0.9≤ky1/ky2≤1.1 is included.

In addition, in the physical quantity sensor 1, as illustrated in FIG. 7, when the acceleration Ax in the X-axis direction is applied, a displacement amount Lx2 of the fixing detection electrode 442A in the X-axis direction caused by the acceleration Ax is equal to a displacement amount Lx1 of the movable detection electrode 441A in the X-axis direction caused by the acceleration Ax. By making the displacement amounts Lx1 and Lx2 equal to each other as described above, even if the acceleration Ax is applied, the gap G between the electrode fingers 4411A and 4421A is not substantially changed. Thus, according to the physical quantity sensor 1, it is possible to reduce influence on the physical quantity (acceleration Ax) other than the angular velocity ωz which is a detection target and to accurately detect the angular velocity ωz. The fact that the displacement amounts Lx1 and Lx2 are equal to each other means that not only a case where the displacement amounts Lx1 and Lx2 coincide with each other (Lx1=Lx2) but also a case where displacement amounts Lx1 and Lx2 are somewhat different from each other, for example, there is a technically unavoidable error and a range of 0.9≤Lx1/Lx2≤1.1 is included.

In the physical quantity sensor 1, the spring constant kx2 of the second spring S2 in the X-axis direction which supports the fixing detection electrode 442A is set to be equal to the spring constant kx1 of the first spring S1 in the X-axis direction which supports the movable detection electrode 441A. Thereby, the displacement amounts Lx1 and Lx2 can be equalized to each other easily and reliably. The fact that the spring constants kx1 and kx2 are equal to each other means not only a case where the spring constants kx1 and kx2 coincide with each other (kx1=kx2) but also a case where the spring constants kx1 and kx2 are somewhat different from each other, for example, there is a technically unavoidable error and a range of 0.9≤kx1/kx2≤1.1 is included.

In addition, in the physical quantity sensor 1, as illustrated in FIG. 8, when an acceleration Az in the Z-axis direction is applied, a displacement amount Lz2 of the fixing detection electrode 442A in the Z-axis direction caused by an acceleration Az is set to be equal to a displacement amount Lz1 of the movable detection electrode 441A in the Z-axis direction caused by the acceleration Az. As such, by making the displacement amounts Lz1 and Lz2 equal to each other as described above, even if the acceleration Az is applied, the gap G between the electrode fingers 4411A and 4421A is not substantially changed. Thus, according to the physical quantity sensor 1, it is possible to reduce influence on the physical quantity (acceleration Az) other than the angular velocity ωz which is a detection target and to accurately detect the angular velocity ωz. The fact that the displacement amounts Lz1 and Lz2 are equal to each other means not only a case where the displacement amounts Lz1 and Lz2 coincide with each other (Lz1=Lz2) but also a case where the displacement amounts Lz1 and Lz2 are somewhat different from each other, for example, there is a technically unavoidable error and a range of 0.9≤Lz1/Lz2≤1.1 is included.

In the physical quantity sensor 1, a spring constant kz1 of the first spring S1 in the Z-axis direction which supports the movable detection electrode 441A is set to be equal to a spring constant kz2 of the second spring S2 in the Z-axis direction which supports the fixing detection electrode 442A. Thereby, the displacement amounts Lz1 and Lz2 can be equalized to each other easily and reliably. In addition, the fact that the spring constants kz1 and kz2 are equal to each other means not only a case where the spring constants kz1 and kz2 coincide with each other (kz1=kz2) but also a case where the spring constants kz1 and kz2 are somewhat different from each other, for example, there is a technically unavoidable error and a range of 0.9≤kz1/kz2≤1.1 is included.

In addition, it is preferable that, in the physical quantity sensor 1, a resonance frequency f1 of a first vibrator including the movable detection electrode 441A and the first spring S1 is different from a resonance frequency f2 of a second vibrator including the fixing detection electrode 442A and the second spring S2. Thereby, the gap G can be kept constant more effectively. While not limited in particular, it is preferable that the resonance frequency f2 is separated from the resonance frequency f1 by 5% or more.

In addition, in the physical quantity sensor 1, if the voltage V1 is applied, an electrostatic attraction force caused by a potential difference between the movable detection electrode 441A and the fixing detection electrode 442A is generated between the movable detection electrode 441A and the fixing detection electrode 442A. As illustrated in FIG. 9, due to the electrostatic attraction force, the fixing detection electrode 442A displaces on the plus side (direction in which the electrode finger 4421A approaches the electrode finger 4411A) in the Y-axis direction while elastically deforming the second spring S2, and the movable detection electrode 441A displaces on the minus side (direction in which the electrode finger 4411A approaches the electrode finger 4421A) in the Y-axis direction while elastically deforming the first spring S1. Thus, in the displacement state, the gap G between the electrode fingers 4411A and 4421A is reduced more than the gap in the natural state. The natural state refers to a state (state where no deformation occurs in the element portion 4) in which no electrostatic attraction force is generated between the movable detection electrode 441A and the fixing detection electrode 442A.

As such, by making the gap G smaller than in the natural state, an electrostatic capacitance formed between the movable detection electrode 441A and the fixing detection electrode 442A is increased, and intensity of the detection signal obtained from the fixing detection electrode 442A is also increased. Accordingly, the angular velocity ωz can be detected more accurately. The gap G can be adjusted by changing a magnitude of the voltage V1 (magnitude of the electrostatic attraction force generated between the movable detection electrode 441A and the fixing detection electrode 442A).

The gap G (see FIG. 10) in the natural state is not limited in particular, and varies depending on performance and the like of a dry etching device used at the time of manufacturing, but it is preferable to be larger than or equal to, for example, approximately 1 μm and smaller than or equal to, for example, approximately 3 μm. Thereby, the gap G in the natural state is sufficiently reduced, and the gap G can be further reduced from that by being set to the displacement state. Accordingly, the electrostatic capacitance formed between the movable detection electrode 441A and the fixing detection electrode 442A is further increased.

The gap G in the displacement state is not limited in particular, but it is preferable for the gap G to be larger than or equal to, for example, approximately 0.1 μm and smaller than or equal to, for example, approximately 1 μm. Thereby, the gap G in the displacement state is sufficiently reduced, and the electrostatic capacitance formed between the movable detection electrode 441A and the fixing detection electrode 442A is increased. In addition, contact between the electrode fingers 4411A and 4421A in the detection vibration mode can be suppressed. It is preferable that the gaps G between the respective plurality of pairs of the electrode fingers 4411A and 4421A are equal as much as possible.

In addition, when a minimum gap between the electrode fingers 4411A and 4421A that can be formed by a dry etching device used for manufacturing the element portion 4 is referred to as Gmin, the gap G in the displacement state is preferably smaller than the minimum gap Gmin. Thereby, it is possible to reduce the gap G in the displacement state beyond a manufacture limitation of the dry etching device. Thus, according to the physical quantity sensor 1, the angular velocity ωz can be detected more accurately.

The movable detection electrode 441A and the fixing detection electrode 442A may not be displaced by the electrostatic attraction force generated by application of the voltage V1. In other words, the spring constant ky1 of the first spring S1 and the spring constant ky2 of the second spring S2 may be set to be sufficiently high so as not to be elastically deformed by the electrostatic attraction force generated by the application of the voltage V1. Thereby, it is impossible to obtain the above-mentioned effects (increase of the electrostatic capacitances Ca and Cb) but, instead, it is possible to suppress excessive softening of the first spring S1 and the second spring S2, and a mechanical strength of the element portion 4 can be maintained sufficiently high.

In addition, the spring 446A located on the plus side (side on which the fixing detection electrode 442A is displaced) in the Y-axis direction includes a portion 4461A that faces the fixing portion 444A in the Y-axis direction, and in the natural state, a gap G1 between a portion 4461A and the fixing portion 444A is smaller than half of the gap G. That is, in the natural state, a relationship of a gap G1<G/2 is satisfied. Thereby, the spring 446A comes into contact with the fixing portion 444A, and thereby, the displacement of the fixing detection electrode 442A more than that is further restricted and the contact between the electrode fingers 4411A and 4421A can be effectively suppressed. Accordingly, the fixing portion 444A functions as a restriction portion 449A (stopper) for restricting excessive displacement of the fixing detection electrode 442A such that the electrode fingers 4411A and 4421A do not come into contact with each other.

Here, in the displacement state, it is preferable that the spring 446A (portion 4461A) is separated from the fixing portion 444A. Thereby, when the acceleration Ay described above is applied, the fixing detection electrode 442A can be displaced in the Y-axis direction together with the movable detection electrode 441A and is less likely to be influenced by the acceleration Ay.

The physical quantity sensor 1 according to the present embodiment is described above. As described above, the physical quantity sensor 1 includes the substrate 2, the movable detection electrode 441A (first detection electrode) including the electrode finger 4411A (first electrode finger), the first spring S1 that supports the movable detection electrode 441A in a displaceable manner in the Y-axis direction (first direction) with respect to the substrate 2, the fixing detection electrode 442A (second detection electrode) including electrode fingers 4421A (second electrode fingers) arranged with a space from the electrode finger 4411A in the Y-axis direction, and the second spring S2 that supports the fixing detection electrode 442A in a displaceable manner in the Y-axis direction with respect to the substrate 2. The spring constant ky1 of the first spring S1 in the Y-axis direction and the spring constant ky2 of the second spring S2 in the Y-axis direction are equal to each other. In other words, when the acceleration Ay in the Y-axis direction is applied, the displacement amount of the movable detection electrode 441A in the Y-axis direction is equal to the displacement amount of the fixing detection electrode 442A in the Y-axis direction. According to the configuration, even if the acceleration Ay in the Y-axis direction is applied, the gap G between the electrode fingers 4411A and 4421A is not substantially changed. Thus, according to the physical quantity sensor 1, it is possible to reduce influence on the physical quantity (acceleration Ay) other than the angular velocity ωz which is a detection target (insensitivity can be increased) and the angular velocity ωz can be accurately detected.

In addition, as described above, the first spring S1 supports the movable detection electrode 441A so as to be displaceable in the X-axis direction (second direction) intersecting the Y-axis direction with respect to the substrate 2, and the second spring S2 supports the fixing detection electrode 442A so as to be displaceable in the X-axis direction with respect to the substrate 2. The spring constant kx1 of the first spring S1 in the X-axis direction is equal to the spring constant kx2 of the second spring S2 in the X-axis direction. In other words, when the acceleration Ax in the X-axis direction is applied, the displacement amount of the movable detection electrode 441A in the X-axis direction is equal to the displacement amount of the fixing detection electrode 442A in the X-axis direction. According to the configuration, even if the acceleration Ax in the X-axis direction is applied, the gap G between the electrode fingers 4411A and 4421A is not substantially changed. Thus, according to the physical quantity sensor 1, it is possible to reduce influence on the physical quantity (acceleration Ax) other than the angular velocity ωz which is a detection target and to accurately detect the angular velocity ωz.

In addition, as described above, the first spring S1 supports the movable detection electrode 441A so as to be displaceable in the Z-axis direction (third direction) intersecting the Y-axis direction and the X-axis direction with respect to the substrate 2, and the second spring S2 supports the fixing detection electrode 442A so as to be displaceable in the Z-axis direction with respect to the substrate 2. A spring constant kz1 of the first spring S1 in the Z-axis direction is equal to a spring constant kz2 of the second spring S2 in the Z-axis direction. In other words, when the acceleration Az in the X-axis direction is applied, the displacement amount of the movable detection electrode 441A in the Z-axis direction is equal to the displacement amount of the fixing detection electrode 442A in the Z-axis direction. According to the configuration, even if the acceleration Az in the Z-axis direction is applied, the gap G between the electrode fingers 4411A and 4421A is not substantially changed. Thus, according to the physical quantity sensor 1, it is possible to reduce influence on the physical quantity (acceleration Az) other than the angular velocity ωz which is a detection target and to accurately detect the angular velocity ωz.

In addition, as described above, in the physical quantity sensor 1, an electrostatic attraction force acts between the electrode finger 4411A and the electrode finger 4421A by applying a potential difference between the movable detection electrode 441A and the fixing detection electrode 442A, the electrode finger 4421A and the electrode finger 4411A are displaced by the electrostatic attraction force so as to approach each other, and the gap G between the electrode finger 4411A and the electrode finger 4421A is reduced more than the gap in the natural state. Accordingly, the electrostatic capacitance between the electrode finger 4411A and the electrode finger 4421A can be increased. In addition, since the gap G can be adjusted after manufacturing, it is possible to optimize the gap G according to processing variations. As a result, it is possible to detect the angular velocity ωz with high sensitivity and high accuracy.

In addition, as described above, the physical quantity sensor 1 includes a restriction portion 449A that restricts the displacement of the fixing detection electrode 442A in the Y-axis direction. Thereby, it is possible to suppress excessive displacement of the fixing detection electrode 442A, and to suppress, for example, breakage of the electrode fingers 4411A and 4421A due to contact between the electrode finger 4411A and the electrode finger 4421A, breakage of the spring 446A, and the like.

In addition, as described above, in the physical quantity sensor 1, the displacement of the fixing detection electrode 442A in the Y-axis direction is restricted by contact between the second spring S2 (spring 446A) and the restriction portion 449A. Thereby, it is possible to suppress excessive displacement of the fixing detection electrode 442A with a relatively simple configuration.

In addition, as described above, the physical quantity sensor 1 is connected to the fixing detection electrode 442A via the second spring S2 (spring 446A) and includes the fixing portion 444A fixed to the substrate 2. The fixing portion 444A serves as the restriction portion 449A. Thereby, a configuration of the element portion 4 is simplified. In addition, it is possible to miniaturize the physical quantity sensor 1.

### Second Embodiment

Next, a physical quantity sensor according to a second embodiment of the invention will be described.

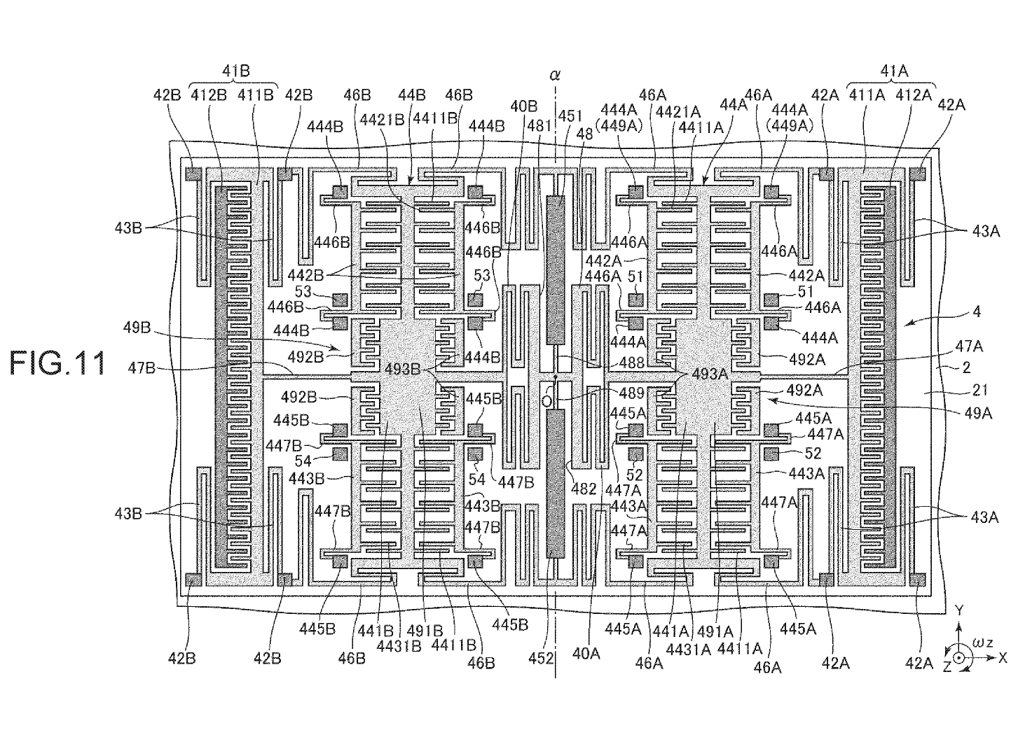

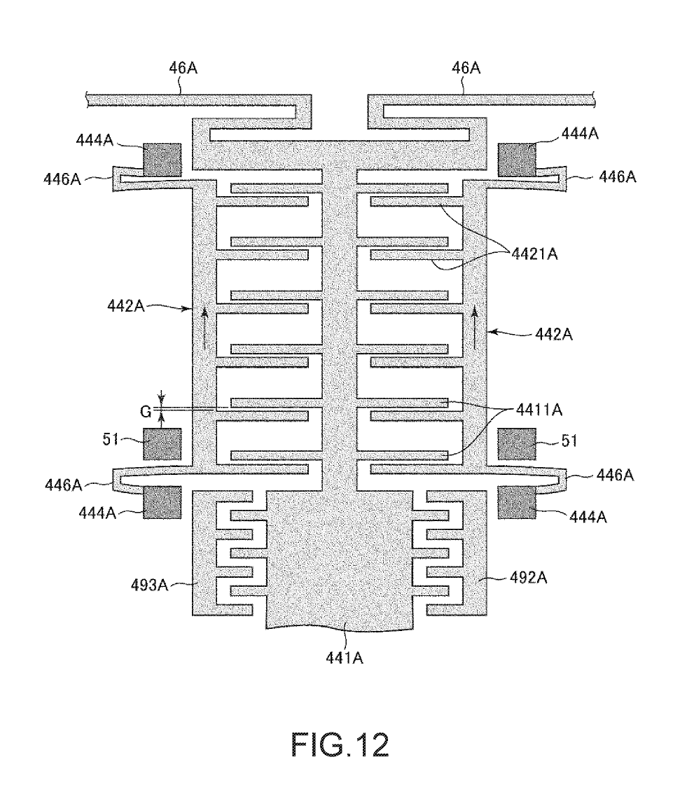

FIG. 11 is a plan view illustrating an element portion of the physical quantity sensor according to the second embodiment of the invention. FIG. 12 is a partially enlarged plan view of the element portion illustrated in FIG. 11.

The physical quantity sensor 1 according to the present embodiment is the same as the physical quantity sensor 1 according to the first embodiment except that a configuration of the element portion 4 is mainly different.

In the following description, differences between the physical quantity sensor 1 according to the second embodiment and the physical quantity sensor 1 according to the first embodiment will be mainly described, and description on the same matters will be omitted. In addition, in FIGS. 11 and 12, the same reference numerals or symbols are given to the same configurations as in the first embodiment described above.

As illustrated in FIG. 11, the element portion 4 includes fixing electrodes 51 arranged in parallel with the springs 446A in the Y-axis direction, fixing electrodes 52 arranged in parallel with the springs 447A in the Y-axis direction, fixing electrodes 53 arranged in parallel with the springs 446B in the Y-axis direction, and fixing electrode 54 arranged in parallel with the springs 447B in the Y-axis direction. Each of the fixing electrodes 51, 52, 53, and 54 is fixed to the substrate 2.

In such a configuration, as illustrated in FIG. 12, by applying a voltage (DC voltage) to the fixing electrode 51, an electrostatic attraction force is generated between the spring 446A and the fixing electrode 51, and the fixing detection electrode 442A is displaced by the electrostatic attraction force in the Y-axis direction. That is, by applying a potential difference between the spring 446A and the fixing electrode 51, the electrostatic attraction force acts between the spring 446A and the fixing electrode 51, and the fixing detection electrode 442A is displaced in the Y-axis direction by the electrostatic attraction force such that the electrode finger 4421A approaches the electrode finger 4411A, and the gap G between the electrode finger 4411A and the electrode finger 4421A is reduced more than the gap in the natural state. The fixing electrodes 52, 53, and 54 also have the same function as the fixing electrode 51.

For example, in the first embodiment described above, the electrostatic attraction force is generated by using the voltage V1 which is a drive voltage, but there is a certain limitation on the voltage V1, and thereby, a magnitude of the voltage V1 cannot be freely changed so much. In contrast to this, in the present embodiment, in order to generate the electrostatic attraction force, a voltage which is different from the voltage V1 and is dedicated to displace the fixing detection electrodes 442A, 443A, 442B, and 443B in the Y-axis direction is used, and thereby, a magnitude of the voltage can be freely changed. Accordingly, an adjustment range and an adjustment accuracy of the gap G are increased, and the angular velocity ωz can be detected more accurately.

The physical quantity sensor 1 according to the second embodiment is described above. The same effects as in the first embodiment described above can be also obtained by the second embodiment.

### Third Embodiment

Next, an inertial measurement device according to a third embodiment of the invention will be described.

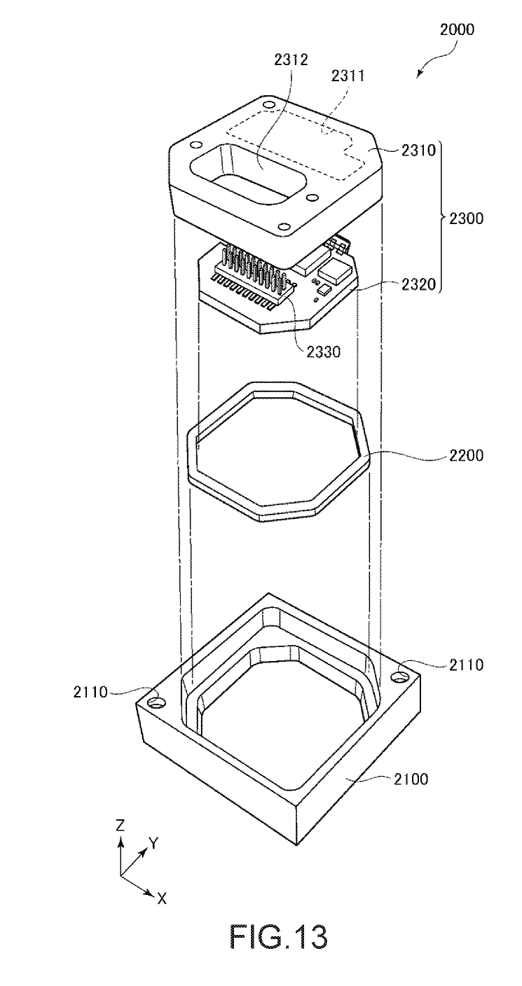

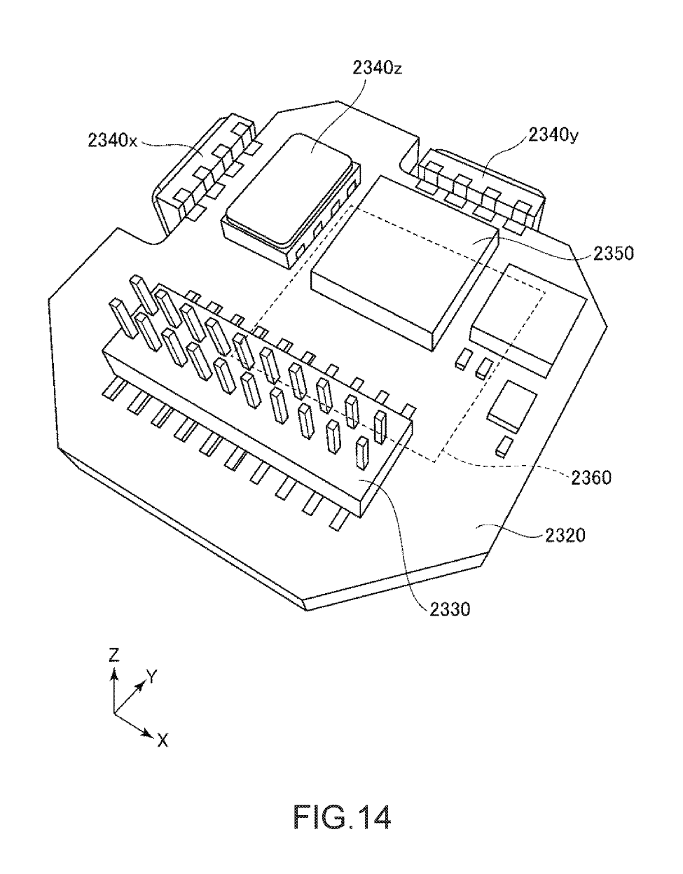

FIG. 13 is an exploded perspective view of the inertial measurement device according to the third embodiment of the invention. FIG. 14 is a perspective view of a substrate included in the inertial measurement device illustrated in FIG. 13.

An inertial measurement device 2000 (IMU: Inertial Measurement Unit) illustrated in FIG. 13 detects a posture and a behavior (inertial momentum) of a vehicle (mounting target device) such as an automobile or a robot. The inertial measurement device 2000 functions as a so-called six-axis motion sensor including a triaxial acceleration sensor and a triaxial angular velocity sensor.

The inertial measurement device 2000 is a rectangular body whose plan shape is a substantially square shape. In addition, a screw hole 2110 serving as a fixing portion is formed near two vertexes located in a diagonal direction of the square shape. The inertial measurement device 2000 can be fixed to a mounting target surface of a mounting target object such as an automobile, via the two screws in the two screw holes 2110. It is also possible to miniaturize a device to a size that can be mounted on, for example, a smartphone or a digital camera by selecting a component or changing a design.

The inertial measurement device 2000 includes an outer case 2100, a bonding member 2200, and a sensor module 2300, and has a configuration in which the sensor module 2300 is inserted into the outer case 2100 with the bonding member 2200 interposed therebetween. In addition, the sensor module 2300 includes an inner case 2310 and a substrate 2320.

An outer shape of the outer case 2100 is a rectangular body whose plan shape is a substantially square shape and includes the screw holes 2110 formed near the two vertexes located in the diagonal direction of the square shape, in the same manner as the overall shape of the inertial measurement device 2000. In addition, the outer case 2100 has a box shape and stores the sensor module 2300 therein.

The inner case 2310 is a member for supporting the substrate 2320 and has a shape to fit inside the outer case 2100. In addition, the inner case 2310 includes a recessed portion 2311 for preventing contact with the substrate 2320 and an opening 2312 for exposing a connector 2330 which will be described below. The inner case 2310 is bonded to the outer case 2100 via the bonding member 2200 (for example, a packing impregnated with an adhesive). In addition, the substrate 2320 is bonded to a lower surface of the inner case 2310 via an adhesive.

As illustrated in FIG. 14, the connector 2330, an angular velocity sensor 2340z that detects an angular velocity around the Z axis, an acceleration sensor 2350 that detects accelerations in the X-axis direction, Y-axis direction, and Z-axis direction are mounted on an upper surface of the substrate 2320. In addition, an angular velocity sensor 2340x that detects an angular velocity around the X axis and an angular velocity sensor 2340y that detects an angular velocity around the Y axis are mounted on a side surface of the substrate 2320. The angular velocity sensors 2340z, 2340x, and 2340y are not limited in particular, and for example, a vibration gyro sensor which uses a Coriolis force can be used therefor. Particularly, any of the configurations of the above-described embodiments can be used for detecting the angular velocity in the Z-axis direction. In addition, the acceleration sensor 2350 is not limited in particular, and for example, an electrostatic capacitance type acceleration sensor can be used therefor.

In addition, a control IC 2360 is mounted on the lower surface of the substrate 2320. The control IC 2360 is a micro controller unit (MCU), has a storage unit including a nonvolatile memory, an A/D converter, and the like embedded therein, and controls each unit of the inertial measurement device 2000. The storage unit stores a program for defining a sequence and content for detecting acceleration and angular velocity, a program for digitizing detected data to incorporate into packet data, accompanying data, and the like. In addition to this, a plurality of electronic components are mounted on the substrate 2320.

The inertial measurement device 2000 (inertial measurement device) is described above. The inertial measurement device 2000 includes the angular velocity sensors 2340z, 2340x, and 2340y and the acceleration sensor 2350 as physical quantity sensors, and the control IC 2360 (control circuit) that controls drive of the respective sensors 2340z, 2340x, 2340y, and 2350. Thereby, it is possible to obtain the effects of the physical quantity sensor according to the invention, and to obtain the inertial measurement device 2000 with a high reliability.

### Fourth Embodiment

Next, a vehicle positioning device according to a fourth embodiment of the invention will be described.

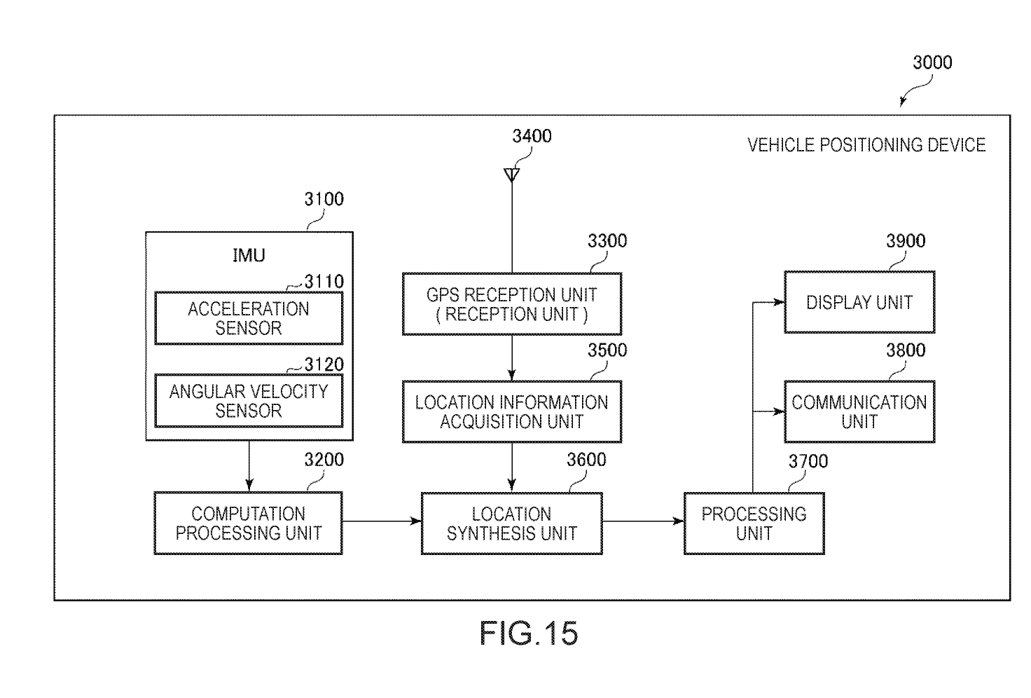

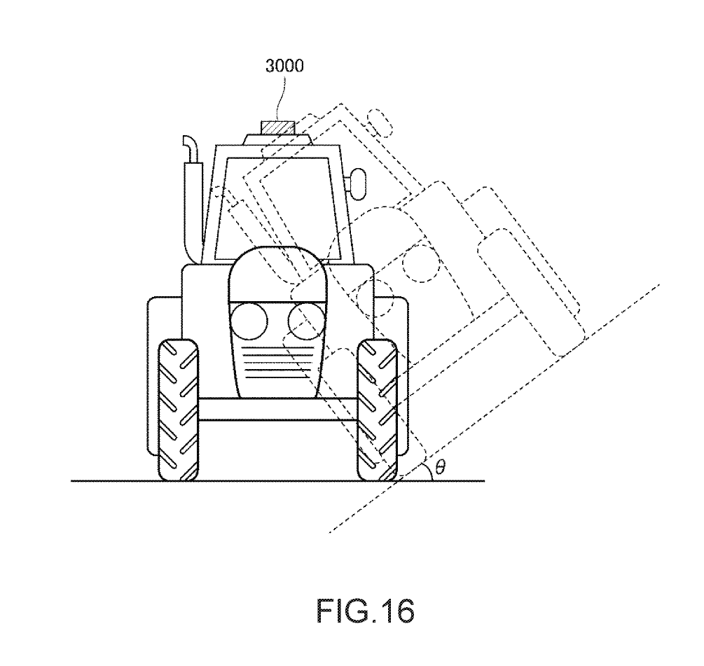

FIG. 15 is a block diagram illustrating the overall system of the vehicle positioning device according to the fourth embodiment of the invention. FIG. 16 is a view illustrating an operation of the vehicle positioning device illustrated in FIG. 15.

A vehicle positioning device 3000 illustrated in FIG. 15 is mounted on a vehicle to be used and performs positioning of the vehicle. The vehicle is not limited in particular, and may be any of a bicycle, an automobile (including a four-wheeled automobile and a motorcycle), a train, an airplane, a ship, and the like, and is described as a four-wheeled vehicle in the present embodiment. The vehicle positioning device 3000 includes an inertial measurement device 3100 (IMU), a computation processing unit 3200, a GPS reception unit 3300, a reception antenna 3400, a location information acquisition unit 3500, a location synthesis unit 3600, a processing unit 3700, a communication unit 3800, and a display unit 3900. For example, the inertial measurement device 2000 of the above-described embodiment can be used as the inertial measurement device 3100.

In addition, the inertial measurement device 3100 includes a triaxial acceleration sensor 3110 and a triaxial angular velocity sensor 3120. The computation processing unit 3200 receives acceleration data from the acceleration sensor 3110 and angular velocity data from the angular velocity sensor 3120, performs inertial navigation computation processing for the data, and outputs inertial navigation positioning data (data including acceleration and posture of the vehicle).

In addition, the GPS reception unit 3300 receives a signal (a GPS carrier wave, a satellite signal in which plural pieces of location information are superimposed) from a GPS satellite via the reception antenna 3400. In addition, the location information acquisition unit 3500 outputs GPS positioning data representing a location (latitude, longitude, altitude), speed, a direction of the vehicle positioning device 3000 (vehicle), based on the signal received by the GPS reception unit 3300. The GPS positioning data also includes status data representing a reception state, a reception time, and the like.

The location synthesis unit 3600 calculates a location of the vehicle, specifically, a location where the vehicle is traveling on the ground, based on the inertial navigation positioning data output from the computation processing unit 3200 and the GPS positioning data output from the location information acquisition unit 3500. For example, even if a location of the vehicle included in the GPS positioning data is the same, as illustrated in FIG. 16, if a posture of the vehicle is changed due to influence of inclination of the ground or the like, it is determined that the vehicle is traveling a different location on the ground. Accordingly, it is impossible to calculate an accurate location of the vehicle with only GPS positioning data. The location synthesis unit 3600 calculates a location where the vehicle is traveling on the ground, by using the inertial navigation positioning data (particularly, the data on the posture of the vehicle). This determination can be made in a comparatively easy manner by computation in which a trigonometric function (inclination θ with respect to a vertical direction) is used.

The location data output from the location synthesis unit 3600 is subjected to predetermined processing by the processing unit 3700 and is displayed on the display unit 3900 as a positioning result. In addition, the location data may be transmitted to an external device by the communication unit 3800.

The vehicle positioning device 3000 is described above. As described above, the vehicle positioning device 3000 includes the inertial measurement device 3100, the GPS reception unit 3300 (reception unit) that receives a satellite signal in which plural pieces of location information are superimposed from a positioning satellite, the location information acquisition unit 3500 (acquisition unit) that acquires the location information of the GPS reception unit 3300, based on the received satellite signal, the computation processing unit 3200 (computation unit) that computes the posture of the vehicle, based on the inertial navigation positioning data (inertia data) output from the inertial measurement device 3100, and the location synthesis unit 3600 (calculating unit) that calculates the location of the vehicle by correcting the location information based on the calculated posture. Thereby, it is possible to obtain the effects of the inertial measurement device according to the invention and to obtain the vehicle positioning device 3000 with a high reliability.

### Fifth Embodiment

Next, an electronic apparatus according to a fifth embodiment of the invention will be described.

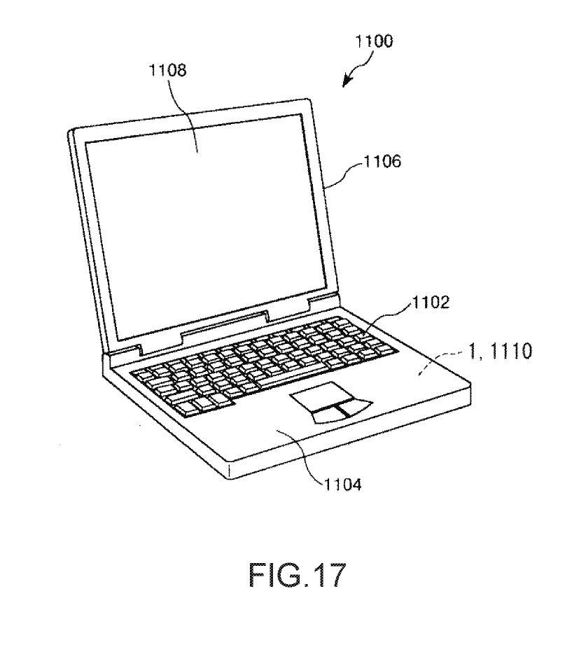

FIG. 17 is a perspective view illustrating the electronic apparatus according to the fifth embodiment of the invention.

A mobile type (or notebook type) personal computer 1100 illustrated in FIG. 17 is an apparatus to which the electronic apparatus according to the invention is applied. In this figure, the personal computer 1100 is configured with a main body portion 1104 including a keyboard 1102, and a display unit 1106 including a display unit 1108. The display unit 1106 is rotatably supported to the main body portion 1104 via a hinge structure portion.

The physical quantity sensor 1 and a control circuit 1110 (control unit) that performs a control based on the detection signal output from the physical quantity sensor 1 are embedded in the personal computer 1100. The physical quantity sensor 1 is not limited in particular, and for example, any of the above-described embodiments can be used.

The personal computer 1100 (electronic apparatus) includes the physical quantity sensor 1 and the control circuit 1110 (control unit) that performs a control based on the detection signal output from the physical quantity sensor 1. Accordingly, the personal computer 1100 (electronic apparatus) can obtain the effects of the above-described physical quantity sensor 1 and can exhibit a high reliability.

### Sixth Embodiment

Next, an electronic apparatus according to a sixth embodiment of the invention will be described.

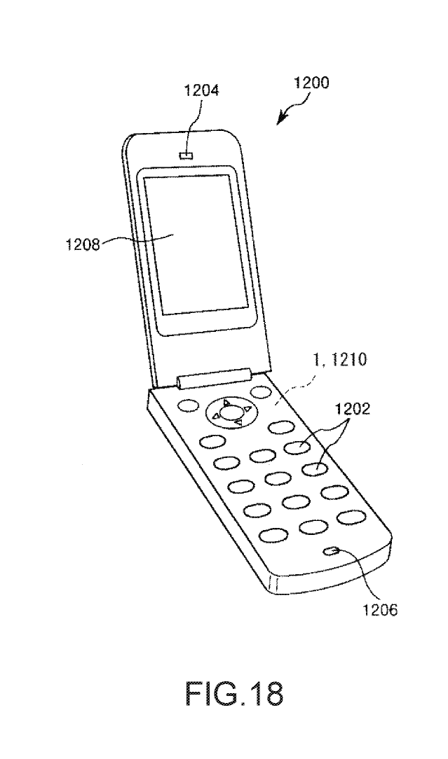

FIG. 18 is a perspective view illustrating the electronic apparatus according to the sixth embodiment of the invention.

A portable phone 1200 (including PHS) illustrated in FIG. 18 is an apparatus to which the electronic apparatus according to the invention is applied. In this figure, the portable phone 1200 includes an antenna (not illustrated), a plurality of operation buttons 1202, an earpiece 1204, and a mouthpiece 1206. A display unit 1208 is disposed between the operation button 1202 and the earpiece 1204.

The physical quantity sensor 1 and a control circuit 1210 (control unit) that performs a control based on the detection signal output from the physical quantity sensor 1 are embedded in the portable phone 1200. The physical quantity sensor 1 is not limited in particular, and for example, any of the above-described embodiments can be used.

The portable phone 1200 (electronic apparatus) described above includes the physical quantity sensor 1 and the control circuit 1210 (control unit) that performs a control based on the detection signal output from the physical quantity sensor 1. Accordingly, the portable phone 1200 (electronic apparatus) can obtain the effects of the above-described physical quantity sensor 1 and can exhibit a high reliability.

### Seventh Embodiment

Next, an electronic apparatus according to a seventh embodiment of the invention will be described.

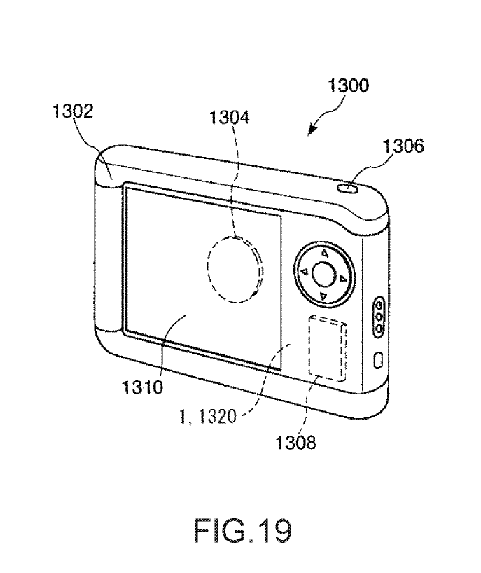

FIG. 19 is a perspective view illustrating the electronic apparatus according to the seventh embodiment of the invention.

A digital still camera 1300 illustrated in FIG. 19 is an apparatus to which the electronic apparatus according to the invention is applied. In this figure, a display unit 1310 is provided on a rear surface of a case 1302, the display unit is configured to perform display based on an image-capturing signal from a CCD, and the display unit 1310 functions as a viewfinder for displaying a subject as an electronic image. In addition, a light receiving unit 1304 including an optical lens (image-capturing optical system), the CCD or the like is provided on a front side (a back side in the figure) of the case 1302. If an image capturing person confirms a subject image displayed on the display unit 1310 and presses a shutter button 1306, an image-capturing signal of the CCD is transferred and stored in the memory 1308 at that time.

The physical quantity sensor 1 and a control circuit 1320 (control unit) that performs a control based on the detection signal output from the physical quantity sensor 1 are embedded in the digital still camera 1300. The physical quantity sensor 1 is not limited in particular, and for example, any of the above-described embodiments can be used.

The digital still camera 1300 (electronic apparatus) includes the physical quantity sensor 1 and the control circuit 1320 (control unit) that performs a control based on the detection signal output from the physical quantity sensor 1. Accordingly, the digital still camera 1300 (electronic apparatus) can obtain the effects of the above-described physical quantity sensor 1 and can exhibit a high reliability.

In addition to the personal computer and the portable phone according to the embodiments described above, and the digital still camera according to the present embodiment, the electronic apparatus according to the invention can be applied to, for example, a smartphone, a tablet terminal, a watch (including a smart watch), an ink jet type ejection device (for example, an ink jet printer), a laptop type personal computer, a television, a wearable terminal such as a head mounted display (HMD), a video camera, a video tape recorder, a car navigation device, a pager, an electronic notebook (including a communication function), an electronic dictionary, a calculator, an electronic game machine, a word processor, a workstation, a videophone, a television monitor for crime prevention, an electronic binocular, a POS terminal, a medical apparatus (for example, an electronic clinical thermometer, a sphygmomanometer, a blood glucose meter, an electrocardiogram measurement device, an ultrasonic diagnostic device, an electronic endoscope), a fish finder, various measuring instruments, an apparatus for mobile terminal base station, instruments (for example, instruments of a vehicle, an aircraft, and a ship), a flight simulator, a network server, and the like.

### Eighth Embodiment

Next, a portable electronic apparatus according to an eighth embodiment of the invention will be described.

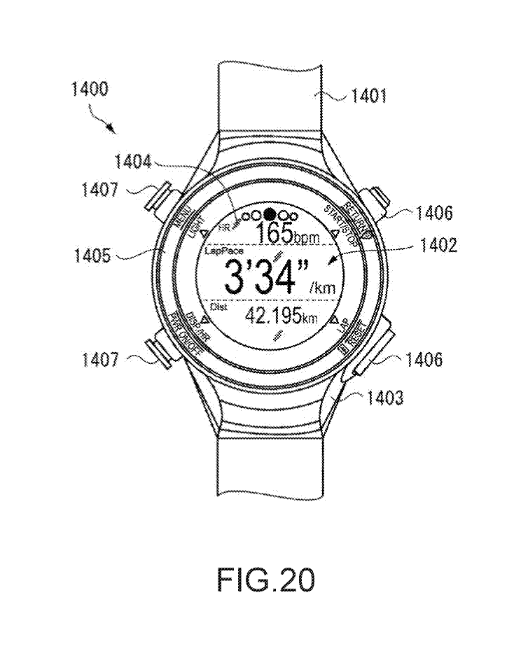

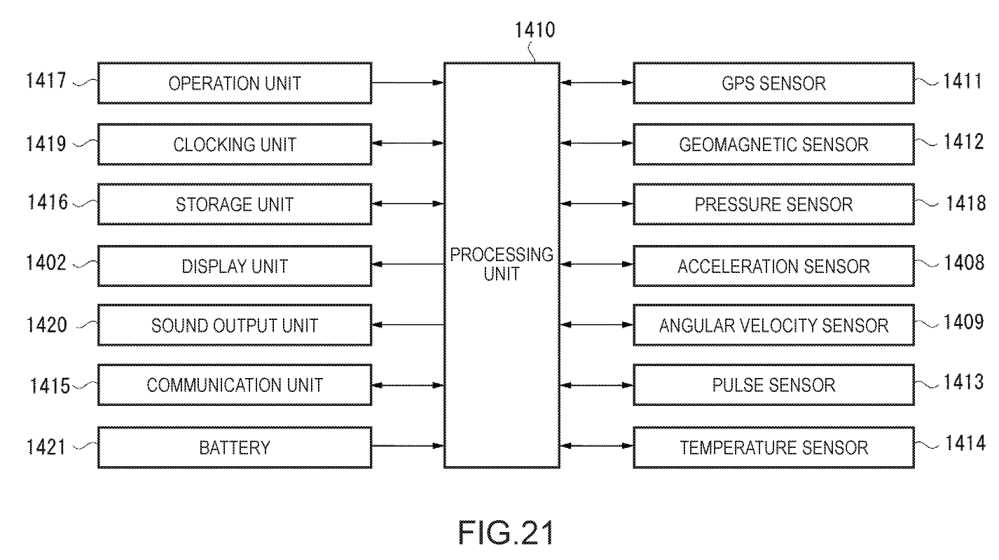

FIG. 20 is a plan view illustrating the portable electronic apparatus according to the eighth embodiment of the invention. FIG. 21 is a functional block diagram illustrating a schematic configuration of the portable electronic apparatus illustrated in FIG. 20.

A watch type activity meter 1400 (active tracker) illustrated in FIG. 20 is a wrist apparatus to which the portable electronic apparatus according to the invention is applied. The activity meter 1400 is attached to a part (subject) such as the wrist of a user by a band 1401. In addition, the activity meter 1400 includes a display unit 1402 for digital display and can perform wireless communication. The physical quantity sensor 1 according to the invention described above is incorporated in the activity meter 1400 as a sensor that measures acceleration or a sensor that measures an angular velocity.

The activity meter 1400 includes a case 1403 storing the physical quantity sensor 1, a processing unit 1410 that is stored in the case 1403 and processes output data from the physical quantity sensor 1, a display unit 1402 stored in the case 1403, and a light-transmitting cover 1404 that closes an opening of the case 1403. In addition, a bezel 1405 is provided outside the light-transmitting cover 1404. In addition, a plurality of operation buttons 1406 and 1407 are provided on a side surface of the case 1403.

As illustrated in FIG. 21, an acceleration sensor 1408 serving as the physical quantity sensor 1 detects accelerations in three axial directions intersecting (ideally orthogonal to) each other, and outputs a signal (acceleration signal) according to magnitudes and orientations of the detected three axial accelerations. In addition, an angular velocity sensor 1409 detects each angular velocity in three axial directions intersecting (ideally orthogonal to) each other, and outputs a signal (angular velocity signal) according to magnitudes and orientations of the detected three axial angular velocities.

A liquid crystal display (LCD) configuring the display unit 1402 displays, for example, location information obtained by using a GPS sensor 1411 or a geomagnetic sensor 1412, exercise information such as the amount of movement or the amount of exercise obtained by using the acceleration sensor 1408 or the angular velocity sensor 1409 included in the physical quantity sensor 1, biometric information such as a pulse rate obtained by using a pulse sensor 1413 or the like, time information such as current time, or the like, depending on various detection modes. It is also possible to display an environmental temperature obtained by using a temperature sensor 1414.

A communication unit 1415 performs various controls for establishing communication between a user terminal and an information terminal (not illustrated). The communication unit 1415 is configured to include, for example, a transmission and reception apparatus corresponding to a short range wireless communication standard such as Bluetooth (registered trademark) (including Bluetooth low energy (BILE)), Wireless-Fidelity (Wi-Fi: registered trademark), Zigbee (registered trademark), near field communication (NFC), and ANT+ (registered trademark), and a connector corresponding to a communication bus standard such as the Universal Serial Bus (USB), and the like.

The processing unit 1410 (processor) is configured with, for example, a micro processing unit (MPU), a digital signal processor (DSP), an application specific integrated circuit (ASIC) or the like. The processing unit 1410 performs various types of processing, based on a program stored in the storage unit 1416 and a signal input from the operation unit 1417 (for example, the operation buttons 1406 and 1407). Processing performed by the processing unit 1410 includes data processing for each output signal of the GPS sensor 1411, the geomagnetic sensor 1412, a pressure sensor 1418, the acceleration sensor 1408, the angular velocity sensor 1409, the pulse sensor 1413, the temperature sensor 1414, and a clocking unit 1419, display processing for displaying an image on the display unit 1402, sound output processing for outputting a sound to a sound output unit 1420, communication processing for communicating with an information terminal via the communication unit 1415, power control processing for supplying power from the battery 1421 to each unit, and the like.

The activity meter 1400 can have at least the following functions.

1. Distance: a total distance from start of measurement performed by a highly accurate GPS function is measured.

2. Pace: a current driving pace is displayed from pace distance measurement.

3. Average speed: average speed from an average speed travel start to a current point of time is calculate and displayed.

4. Altitude: altitude is measured and displayed by the GPS function.

5. Stride: a stride is measured and displayed even in a tunnel where a GPS radio wave does not reach.

6. Pitch: the number of steps per minute is measured and displayed.

7. Heart rate: a heart rate is measured and displayed by a pulse sensor.

8. Gradient: a gradient of the ground is measured and displayed in training and trail runs in the mountain.

9. Auto wrap: when a person runs for a fixed distance set in advance or for a fixed time, a lap measurement is automatically performed.

10. Exercise consumption calorie: burned calories are displayed.

11. Step count: the total number of steps from exercise start is displayed.

The activity meter 1400 (portable electronic apparatus) includes the physical quantity sensor 1, the case 1403 storing the physical quantity sensor 1, the processing unit 1410 that is stored in the case 1403 and processes output data from the physical quantity sensor 1, the display unit 1402 stored in the case 1403, and the light-transmitting cover 1404 closing an opening of the case 1403. Accordingly, the activity meter 1400 (portable electronic apparatus) can obtain the effects of the physical quantity sensor 1 described above and can exhibit a high reliability.

The activity meter 1400 can be widely applied to a running watch, a runner's watch, a runner's watch corresponding to multi-sports such as duathlon and triathlon, an outdoor watch, a satellite positioning system such as a GPS watch in which GPS is mounted, and the like.

In addition, in the above description, a global positioning system (GPS) is used as a satellite positioning system, but another global navigation satellite system (GNSS) may be used. For example, one or more of the satellite positioning systems such as a European geostationary satellite navigation overlay service (EGNOS), a Quasi Zenith satellite system (QZSS), a global navigation satellite system (GLONASS), GALILEO, and a Bei Dou navigation satellite system (Bei Dou) may be used. In addition, a stationary satellite type satellite-based augmentation system (SBAS) such as a wide area augmentation system (WAAS), and a European geostationary-satellite navigation overlay service (EGNOS) may be used to at least one of the satellite positioning system.

### Ninth Embodiment

Next, a vehicle according to a ninth embodiment of the invention will be described.

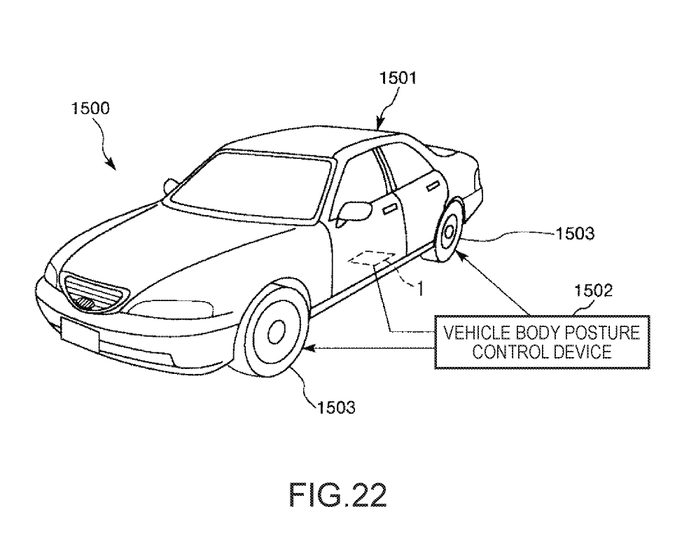

FIG. 22 is a perspective view illustrating the vehicle according to the ninth embodiment of the invention.

An automobile 1500 illustrated in FIG. 22 is an automobile to which the vehicle according to the invention is applied. In this figure, the physical quantity sensor 1 is embedded in the automobile 1500 and a posture of a vehicle body 1501 can be detected by the physical quantity sensor 1. A detection signal of the physical quantity sensor 1 is supplied to a vehicle body posture control device 1502 (posture control unit), and the vehicle body posture control device 1502 can detect the posture of the vehicle body 1501 based on the signal and can control hardness of a suspension in accordance with the detection results or control a brake of each of wheels 1503. Here, for example, the same unit as in the respective embodiments described above can be used as the physical quantity sensor 1.

The automobile 1500 (vehicle) includes the physical quantity sensor 1 and a vehicle body posture control device 1502 (control unit) that performs a control based on the detection signal output from the physical quantity sensor 1. Accordingly, the automobile 1500 (vehicle) can obtain the effects of the above-described physical quantity sensor 1 and can exhibit a high reliability.

In addition to this, the physical quantity sensor 1 can be widely applied to a car navigation system, a car air conditioner, an anti-lock braking system (ABS), an air bag, a tire pressure monitoring system (TPMS), an engine control, and an electronic control unit (ECU) such as a battery monitor of a hybrid vehicle or an electric vehicle.

In addition, the vehicle is not limited to the automobile 1500, and can also be applied to, for example, an airplane, a rocket, an artificial satellite, a ship, an automated guided vehicle (AGV), a biped walking robot, an unmanned airplane such as a drone, and the like.

As described above, although a physical quantity sensor, an inertial measurement device, a vehicle positioning device, a portable electronic apparatus, an electronic apparatus, and a vehicle according to the invention are described based on the illustrated embodiments, the invention is not limited to this, and configurations of each portion can be replaced with any configuration having the same function. In addition, any other configuration unit may be added to the invention. In addition, the above-described embodiments may be appropriately combined.

In addition, in the above-described embodiment, a case where an angular velocity is detected by a physical quantity sensor is described, but the invention is not limited to this, and, for example, an acceleration may be detected. In addition, both the acceleration and the angular velocity may be detected.

What is claimed is:

1. A physical quantity sensor comprising:
a substrate;
a first detection electrode that includes a first electrode finger;
a first spring that supports the first detection electrode in a displaceable manner in a first direction with respect to the substrate;
a second detection electrode that includes a second electrode finger which is disposed at a distance from the first electrode finger in the first direction; and
a second spring that supports the second detection electrode in a displaceable manner in the first direction with respect to the substrate,
wherein a spring constant of the first spring in the first direction is equal to a spring constant of the second spring in the first direction.

2. The physical quantity sensor according to claim 1,
wherein the first spring supports the first detection electrode in a displaceable manner in a second direction intersecting the first direction with respect to the substrate,
wherein the second spring supports the second detection electrode in a displaceable manner in the second direction with respect to the substrate, and
wherein a spring constant of the first spring in the second direction is equal to a spring constant of the second spring in the second direction.

3. The physical quantity sensor according to claim 1,
wherein the first spring supports the first detection electrode in a displaceable manner in a third direction intersecting each of the first and second directions with respect to the substrate,
wherein the second spring supports the second detection electrode in a displaceable manner in the third direction with respect to the substrate, and
wherein a spring constant of the first spring in the third direction is equal to a spring constant of the second spring in the third direction.

4. The physical quantity sensor according to claim 1,
wherein an electrostatic attraction force acts between the first electrode finger and the second electrode finger by applying a potential difference between the first detection electrode and the second detection electrode, and
wherein the second electrode finger and the first electrode finger are displaced so as to approach each other by the electrostatic attraction force, and a gap between the first electrode finger and the second electrode finger is reduced more than a gap in a natural state.

5. The physical quantity sensor according to claim 1, further comprising:
a fixing electrode that is disposed in parallel with the second spring in the first direction,
wherein an electrostatic attraction force acts between the second spring and the fixing electrode by applying a potential difference between the second spring and the fixing electrode, and
wherein the second detection electrode is displaced in the first direction by the electrostatic attraction force, and a gap between the first electrode finger and the second electrode finger is reduced more than a gap in a natural state.

6. The physical quantity sensor according to claim 4, further comprising:
a restriction portion that restricts a displacement of the second detection electrode in the first direction.

7. The physical quantity sensor according to claim 6,
wherein, as the second spring comes into contact with the restriction portion, the displacement of the second detection electrode in the first direction is restricted.

8. The physical quantity sensor according to claim 6, further comprising:
a fixing portion that is connected to the second detection electrode via the second spring and is fixed to the substrate,
wherein the fixing portion serves as the restriction portion.

9. A physical quantity sensor comprising:
a substrate;
a first detection electrode that includes a first electrode finger;
a first spring that supports the first detection electrode in a displaceable manner in a first direction with respect to the substrate;
a second detection electrode that includes a second electrode finger which is disposed at a distance from the first electrode finger in the first direction; and
a second spring that supports the second detection electrode in a displaceable manner in the first direction with respect to the substrate,
wherein, when an acceleration in the first direction is applied, a displacement amount of the first detection electrode in the first direction is equal to a displacement amount of the second detection electrode in the first direction.

10. The physical quantity sensor according to claim 9,
wherein the first spring supports the first detection electrode in a displaceable manner in a second direction intersecting the first direction with respect to the substrate,
wherein the second spring supports the second detection electrode in a displaceable manner in the second direction with respect to the substrate, and
wherein, when an acceleration in the second direction is applied, a displacement amount of the first detection electrode in the second direction is equal to a displacement amount of the second detection electrode in the second direction.

11. The physical quantity sensor according to claim 9,
wherein the first spring supports the first detection electrode in a displaceable manner in a third direction intersecting each of the first and second directions with respect to the substrate,
wherein the second spring supports the second detection electrode in a displaceable manner in the third direction with respect to the substrate, and
wherein, when an acceleration in the third direction is applied, a displacement amount of the first detection electrode in the third direction is equal to a displacement amount of the second detection electrode in the third direction.

12. An inertial measurement device comprising:
the physical quantity sensor according to claim 1; and
a control circuit that controls a drive of the physical quantity sensor.

13. An inertial measurement device comprising:
the physical quantity sensor according to claim 2; and
a control circuit that controls a drive of the physical quantity sensor.

14. A vehicle positioning device comprising:
the inertial measurement device according to claim 12;
a reception unit that receives a satellite signal in which plural pieces of location information are superimposed from a positioning satellite;
an acquisition unit that acquires the location information of the reception unit, based on the received satellite signal;
a computation unit that computes a posture of a vehicle, based on inertia data that is output from the inertial measurement device; and
a calculation unit that calculates a location of the vehicle by correcting the location information, based on the calculated posture.

15. A portable electronic apparatus comprising:
the physical quantity sensor according to claim 1;
a case that stores the physical quantity sensor;
a processing unit that is stored in the case and processes output data from the physical quantity sensor;
a display unit that is stored in the case; and
a light-transmitting cover that covers an opening of the case.

16. A portable electronic apparatus comprising:
the physical quantity sensor according to claim 2;
a case that stores the physical quantity sensor;
a processing unit that is stored in the case and processes output data from the physical quantity sensor;
a display unit that is stored in the case; and
a light-transmitting cover that covers an opening of the case.

17. An electronic apparatus comprising:
the physical quantity sensor according to claim 1;
a control unit that performs a control based on a detection signal which is output from the physical quantity sensor.

18. An electronic apparatus comprising:
the physical quantity sensor according to claim 2;
a control unit that performs a control based on a detection signal which is output from the physical quantity sensor.

19. A vehicle comprising:
the physical quantity sensor according to claim 1; and
a control unit that performs a control based on a detection signal which is output from the physical quantity sensor.

20. A vehicle comprising:
the physical quantity sensor according to claim 2; and
a control unit that performs a control based on a detection signal which is output from the physical quantity sensor.
